(19) United States
(12) Patent Application Publication
(10) Pub. No.: US 2015/0293632 A1
(43) Pub. Date: Oct. 15, 2015

(54) E-Book Reader with Enhanced Search Features

(71) Applicant: Roddy McKee Bullock, Milford, OH (US)

(72) Inventor: Roddy McKee Bullock, Milford, OH (US)

(21) Appl. No.: 14/749,611

(22) Filed: Jun. 24, 2015

Related U.S. Application Data
(63) Continuation of application No. 12/983,182, filed on Dec. 31, 2010.
(60) Provisional application No. 61/362,640, filed on Jul. 8, 2010.
(60) Provisional application No. 61/345,115, filed on May 15, 2010.

(51) Int. Cl. G06F 3/044; G06F 3/0484; G06F 3/0482; G06K 9/20; G06F 17/30; G06F 3/0483; G06F 3/0488

(52) U.S. Cl. CPC G06F 3/044; G06F 3/0483; G06F 3/04842; G06F 3/0488; G06K 9/2054; G06F 17/30657; G06F 3/0484; G06F 3/0482; G06F 2203/04103

(57) ABSTRACT

An e-book reader. The e-book reader can have a touch screen, the touch screen being an electronic paper display having a contrast ratio greater than 7:1. The e-book reader can weigh between 100 and 300 grams and have internal memory for storing a source file of an electronic work, the source file being stored in the memory in AZW format. The electronic work can be a work of fiction having a storyline and further include searchable information relevant to a person, a place, or a thing in the work of fiction and provide the information after a human reader touches the touch screen at a location displaying the person, the place, or the thing. The information can remind the human reader of the person's, the place's or the thing's relationship to the storyline.

### PRIORITY APPLICATIONS

This application is a continuation of U.S. Ser. No. 12/983,182, entitled Enhanced E-Book and Enhanced E-Book Reader, filed May 15, 2010 filed Dec. 31, 2010. This application claims benefit of U.S. Provisional Application No. 61/362,640 entitled Enhanced E-Book and Enhanced E-Book Reader, filed Jul. 8, 2010. This application also claims benefit of to U.S. 61/345,115, entitled Enhanced E-Book and Enhanced E-Book Reader, filed May 15, 2010.

### FIELD OF THE INVENTION

This invention relates to electronic e-books, e-book readers, and enhancements thereto, including enhanced search features.

### BACKGROUND OF THE INVENTION

Electronic book readers, hereinafter called e-book readers, are utilized to read electronic books, hereinafter e-books. E-books offer many benefits and advantages over traditional ink and paper technology. There are environmental benefits as no trees need be cut down for paper. There are space benefits for the avid reader, as many books in the form of e-books can be stored on, and retrieved from, a small device. The savings in space, as well as the advantage of lighter weight, allow greater portability and accessibility to the written word, whether it is a book, newspaper, magazine, or other of traditional print media in the form of an electronic source file.

One of the drawbacks to reading books in an electronic medium, including on computers, “pad” devices such as the iPad®, e-book readers such as the Amazon Kindle®, or other electronic format, is the inability to easily “flip back” to a previous page to re-read a portion, or to be reminded of the importance, relevance, or simply the facts of a certain scene, character, place or plot line. While e-book readers have a “previous page” function (or equivalent), or a “find” or “search” function (or equivalent), such functions are slow and awkward to use.

Sometimes a reader of a novel reads a portion involving a particular character and can't remember who such character is, or the character's relevance to the particular scene. Or a reader may read about a place in a novel, the place having been introduced earlier, and the reader can't remember the place or the place's significance in the story. Or, sometimes the reader may read about a certain event, and need to be reminded of the event's significance in the novel's plotline. Or the reader may simply wish to know a word's definition (as used in context), or place's history (as it relates to the context of the work), or other information related to the novel. Other reasons to “flip pages” in a traditional book, such as accessing a glossary, consulting an index, reviewing a list of photos, reading a bibliography, and checking footnotes, make reading e-books on e-book readers cumbersome.

A reader of non-fiction, such as a newspaper or magazine, likewise might wish to know more about a particular word, phrase, place, or thing in the piece being read.

Currently some online sources provide hyperlinks to definitions or other information on a particular name or term. But such links do not relate back to information in the same online piece, that is they are not context-specific. So a provided definition may not offer the meaning intended in the particular context of the written piece, and is, therefore, unhelpful. Likewise a link on a person's or object's name merely leads to generic online information.

There is an unmet need for a way to quickly and easily get information, including information on scenes, characters, places, plot lines, and the like, as well as words, phrases, subjects, and other things one comes across when reading a work electronically, such as in an e-book on an e-book reader.

In particular, there is an unmet need for a convenient device and method for rendering various activities associated with traditional paper and ink print media, such as “flipping pages” to go forward or backward to quickly get information relevant to a particular place or page being read in a work displayed on an electronic screen, particularly an e-book reader, whether it be in the form of a dedicated e-book reader, a pad device, a smartphone, or the like.

There is an unmet need to provide to readers in electronic media, including e-books, context-specific information to aid a human reader in understanding the piece being read on an e-book reader.

Another drawback to current e-book readers is the inability to easily search for terms in the e-book without necessarily engaging in the cumbersome process of typing in a term on a small keyboard and then stepping through a tedious sequential process of searching.

There is an unmet need to provide to readers in electronic media, including e-books, improved searching capability for context-relevant information.

Learning a new language, or a second language different from one's first, or native, language, has proved to be a challenge despite many systems and methods for learning a new language.

There is a continuing unmet need to provide people a way to learn a second, or new, language.

Another drawback to use of electronic devices, including mobile phones, pad-type computers, and e-book readers which use touchscreen technology is the relative difficulty in ensuring that relatively small text or relatively small icons can be selected effectively. On small screens the size of one's finger or thumb can block out the portion of the screen for which a selection is desired, thereby making accurate selection by pressing a specific portion of a touchscreen difficult.

There is a continuing unmet need for an easier to use touchscreen for electronic devices.

### SUMMARY OF THE INVENTION

An e-book reader is disclosed. The e-book reader can have a touch screen, the touch screen being an electronic paper display having a contrast ratio greater than 7:1. The e-book reader can weigh between 100 and 300 grams and have internal memory for storing a source file of an electronic work, the source file being stored in the memory in AZW format. The electronic work can be a work of fiction having a storyline and further include searchable information relevant to a person, a place, or a thing in the work of fiction and provide the information after a human reader touches the touch screen at a location displaying the person, the place, or the thing. The information can remind the human reader of the person's, the place's or the thing's relationship to the storyline.

### BRIEF DESCRIPTION OF THE DRAWINGS

FIG. 1 is a plan view of one embodiment of an enhanced e-book reader of the present invention.

FIG. 2 is a plan view of one embodiment of an enhanced e-book reader of the present invention.

FIG. 3 is a plan view of one embodiment of an enhanced e-book reader of the present invention.

FIG. 4 is a plan view of one embodiment of an enhanced e-book reader of the present invention.

FIG. 5 is a plan view of one embodiment of an enhanced e-book reader of the present invention.

FIG. 6 is a plan view of one embodiment of an enhanced e-book reader of the present invention.

FIG. 7 is a depiction of an embodiment of a look-up table or database for use in an enhanced e-book of the present invention.

FIG. 8 is a depiction of an embodiment of a look-up table or database for use in an enhanced e-book of the present invention.

FIG. 9 is a plan view of one embodiment of an enhanced e-book reader of the present invention.

FIG. 10 is a plan view of one embodiment of an enhanced e-book reader of the present invention.

FIG. 11 is a plan view of one embodiment of an enhanced e-book reader of the present invention.

FIG. 12 is a plan view of one embodiment of an enhanced e-book reader of the present invention.

FIG. 13 is a plan view of one embodiment of an enhanced e-book reader of the present invention.

FIG. 14 is a plan view of one embodiment of an enhanced e-book reader of the present invention.

FIG. 15 is a plan view of one embodiment of an enhanced e-book reader of the present invention.

FIG. 16 is a plan view of one embodiment of an enhanced e-book reader of the present invention.

FIG. 17 is a plan view of one embodiment of an enhanced e-book reader of the present invention.

FIG. 18 is a plan view of one embodiment of an enhanced e-book reader of the present invention.

FIG. 19 is a plan view of one embodiment of an enhanced e-book reader of the present invention.

FIG. 20 is a plan view of one embodiment of an electronic device of the present invention.

FIG. 21 is a plan view of one embodiment of an enhanced e-book reader of the present invention.

### DETAILED DESCRIPTION OF THE INVENTION

As used herein, the term “reader” or “e-book reader” is used with reference to electronic devices used for presenting reading material to a human reader. Thus, a distinction is intended to be made throughout between a “reader”, referring to a device, and a “human reader”, referring to the person reading from the electronic device.

The present invention can be practiced on any electronic device having a screen from which a human reader can read words. The screen can also display icons, images, graphics, hyperlinks, and any other of common computer- and internet-related objects. The device can be a desktop computer, a laptop computer, a note-book computer, a “tablet” computer, a “pad” device, a Smartphone device, or a dedicated e-book reader. By “e-book reader” is meant an electronic device the primary purpose of which is to electronically display for reading by a human reader books, newspapers, magazines, or other electronic representations of traditional print media. An example of an e-book reader is the Amazon Kindle® brand of devices. The enhanced e-book reader of the present invention is an improvement over known e-book readers which otherwise can utilize all structures, features, and configurations (both physical and electronic) of current, known e-book readers.

Current e-books (and traditional books converted to e-books) can be modified to be an enhanced e-book of the present invention by making modifications to the source file of the electronic work as disclosed herein and/or by the incorporation in the device memory additional files accessible by the device's executable instructions. Source files of any known format can be modified to include the features of enhanced e-books, including the inclusion of a, or linking to a remote, look-up table or database, as disclosed herein below. Current e-book readers can be modified to be an enhanced e-book reader of the present invention by making modifications to software, executable instructions, memory, and other “soft” features of e-book reader technology to implement the inventive features disclosed herein.

The invention is disclosed herein in its best mode as being implemented on an e-book reader. Current e-book readers that can be enhanced by implementation of the present invention include, without limitation, Amazon Kindle®, Amazon Kindle 2, Amazon Kindle DX, Sony PRS-300, Sony PRS-505, Sony PRS-600, Sony PRS-700, Sony Portable Reader Touch Edition, Sony Daily Reader, Sony Portable Edition Pocket Edition, Cybook Opus, iRex Iliad 2, iRex Dgtl Reader, HanLin e-book V3, HanLin e-book V5, HanLin e-book V3+, HanLin e-book A6, HanLin e-book Be-book mini, HanLin e-book EZ Reader, HanLin e-book Pocket PRO, eGriver eReader IDEO, eGriver eReader Touch, Bookeen Cybook Gen3, Bookeen Cybook Opus, COOL-ER Classic, Kobo eReader, Pocketbook 301 Plus, Pocketbook 302, Pocketbook 360, ViewSonic VEB620, ViewSonic VEB625, Viewsonic 612, NUUTbook NUUT2, iriver Story, Onyx Boox 60, Onyx Be-book Neo, Barnes and Noble Nook, Spring Design Alex, Hanvon WISEreader N526, Hanvon N518, Hanvon N520, Elonex, 511EB, Hanvon HandyBOOK N516, Azbooka 516, Foxit eSlick, Astak EZPro, Astak Mentor, and new editions and upgrades thereof.

An enhanced e-book reader can have dimensions ranging from about 140-225 mm long, 100-140 mm wide, and about 8-16 mm thick. An e-book reader can weigh between about 100-300 g. An enhanced e-book reader can run on a Linux operating system, can have a Samsung S3C2440 CPU, can have 32-64 MG RAM or more, and 1-4 GB internal memory or more, and can utilize a Lithium-ion battery having from about 900-2000 mAh. All such dimensions and parameters are subject to future improvements, of course, and all future improvements can be beneficial to the operation of e-book readers in general, and to the enhanced e-book reader of the present invention specifically.

An enhanced e-book reader can have a touchscreen. A touchscreen can serve as an input device in addition to, or instead of, a keyboard or directional pad. Examples of e-book readers with touchscreens are believed to include one or more of Hanvon WISEreader N518, eGriver eReader Touch, HanLin e-book A6, Sony Portable Reader Touch Edition, Pocketbook 302, Onyx Boox 60, Barnes and Noble Nook, and Spring Design Alex. Touchscreen capability can be by touch of a human digit, such as a finger, or by stylus. A touchscreen permits various functions of the enhanced e-book reader to be performed by direct touching of the screen. Examples of e-book readers utilizing a keyboard and a directional pad include the Amazon Kindle 2, and the Amazon Kindle DX. Examples of e-book readers utilizing a directional pad include the Sony PRS-300, and Cybook Opus.

An enhanced e-book reader can incorporate E Ink Vizplex technology for a black and white ink-on-paper look from E Ink Corporation, Cambridge, Mass., USA. Commonly referred to as Electronic Paper Displays, such displays can have a white state reflectivity of about 40%, a contrast ratio of about 7.1 or better, a viewing angle of about 180 degrees, a grayscale capability of 4-bit, and a typical image update time of about 260 ms. Display thickness can be about 1.2 mm, and can have pixel counts up to 1024×768 for an 8-inch display and 1200×825 for a 9.7-inch display. Other screen technologies include SiPix display modules, including SiPix Microcup®, from SiPix Imaging, Inc., Fremont, Calif., USA. All such parameters are subject to future improvements, of course, and all future improvements can be beneficial to the operation of e-book readers in general, and to the enhanced e-book reader of the present invention specifically.

Touchscreen technology as known in the art can be used in the enhanced e-book reader of the present invention. For example, the touchscreen technology utilized in the Sony Portable Reader Touch Edition can be utilized. Sony's Portable Reader Touch Edition, permits a reader to highlight, underline, and take notes utilizing the touchscreen, as well as search terms and use the built-in dictionary. In general, touchscreen technology of an enhanced e-book reader can utilize 4- or 5-wire resistive technology, capacitive technology, PenTouch capacitive technology, surface acoustic wave technology, near field imaging technology, or infrared technology, all the above available from Mass Multimedia, Inc., Colorado Springs, Colo., USA (www.touchscreens.com).

Touchscreen technology suitable for the present invention also encompasses screens such as TrueTouch® screen controllers made by Cypress, San Jose, Calif., USA. Cypress TrueTouch® Touchscreen technology using projected capacitance for improved optical clarity, damage resistance, and cost-effective multi-touch, compared to other touchscreen methods. Some touchscreen technology can detect hovering movements, not just direct contact, so that a user need only bring a finger tip close to the surface of the screen to start an action. Also, some touchscreens, such as the Generation 3 TrueTouch® Solution by Cypress, can detect and act upon multiple simultaneous touches, including tracking movement of individual fingers. The enhanced e-book of the present invention can utilize all known touchscreen technologies, as well as all future-developed compatible technologies.

Any known method, and any future-developed methods, of selecting a term, word, phrase, or section of a screen on an electronic device, such as an e-book reader, can be used in the enhanced e-book of the present invention. For example, selecting by touch on a touchscreen, or stylus on a touchscreen, by curser movement, keyboard entry, directional pad operation, or by mouse input can be used. In general, once a word, phrase, or section is selected, an action takes place passively, or by further human interaction. By “passively” is meant that no other human interaction need happen beyond the selection event to trigger further enhanced e-book reader function. That is, the benefits of present invention can be achieved with “1-click” or “one touch” or the like, in which a single action of the human reader triggers the enhanced e-book function. For example, if the definition of a word is desired, a human finger can touch a touchscreen at the location of the word, and the definition can (without further human interaction) appear on the screen. In another embodiment, a human reader can touch a word on a touchscreen to cause a second prompt, such as a second screen menu, to appear, and from which the human reader can then select an action, such as “dictionary” or “thesaurus” or “rhymes” or “translate” or the like. In another embodiment the electronic device, such as an enhanced e-book reader can operate on a default setting of “dictionary” or “thesaurus” or “rhymes” or “translate”, and unless the human reader chooses another setting the one-touch single action feature operates on the default setting. Other methods of functional selecting are disclosed further below.

E-books can be in many formats, and e-book readers are configured to display one or more of the formats. For example, the Amazon Kindle® is believed to work for the following source file formats: natively: AZW, TXT, Audible, MP3, unprotected MOBI, PRC; through conversion: PDF, HTML, DOC, JPEG, GIF, PNG, BMP. Likewise, the Barnes and Noble Nook® is believed to be formatted for the following: PDF, EPUB, eReader, PDB, JPG, GIF, PNG, BMP, MP3. The Sony PRS-700 is believed to be formatted for the following source files: BBeB (LRF/LRX), PDF, EPUB, TXT, RTF, JPG, BMP, GIF, PNG, MP3, AAC. An enhanced e-book of the present invention can have a source file in any of the existing formats, and the enhanced e-book reader of the present invention can employ executable instructions in memory to display existing source file formats, as well as any compatible future-developed formats.

Current e-books are essentially converted print books. That is, current e-books are electronically-formatted versions of their respective print counterparts. Some e-book readers provide a dictionary function, in which a human reader can select a word and a dictionary definition appears on screen. Some e-book readers also have a footnote function, in which a human reader selects a footnote indicator, and a footnote appears on screen. The Amazon Kindle® provides both of these functions. Otherwise, current e-books offer the human reader no additional information over what is found in the corresponding print edition.

Enhanced e-books take advantage of the power of computing and electronic ink technology to provide a human reader with new levels of reading enjoyment and comprehension by providing ancillary, context-specific information related to the piece being read on an enhanced e-book reader of the present invention. For example, a human reader of a news article on the country of Panama can touch the word Panama, and context-specific information on the country of Panama can appear on screen. In another embodiment, a reader of a novel involving many characters can, at any point in the novel, touch a character's name, and an on-screen display can give identifying information to remind the reader of the character's relationship to other characters and events in the novel. In another embodiment, a reader of non-fiction can touch a word or phrase on screen and get an on-screen contextually-relevant message relating to the subject matter of the non-fiction reading. In another embodiment, a human reader desiring to learn a second language can read an enhanced e-book on an enhanced e-book reader in the second language, and upon selecting a term, sentence, phrase, or the like, can be presented with a translation into the human reader's first, or native, language.

One difference between current e-book and e-book reader technology and the enhanced e-book and e-book reader of the present invention lies in the type of information available to the human reader, as well as the manner in which it is accessed, when using the enhanced e-book reader to read an enhanced e-book. In current e-book technology, any additional information available to a human reader is general or generic, e.g., standard dictionary definitions, standard encyclopedic entries, and other information from a counterpart print edition, such as footnotes, bibliography, glossary, index, and the like, and often must be accessed by cumbersome typing on a small keyboard, navigation via a small pointing device, or the like. Such information may or may not be helpful to a human reader, as the context of the piece being read may be enhanced by a context-specific understanding not reflected in general or generic reference information.

Thus, the enhanced e-book of the present invention can include in its electronic format source file (or a file accessible from the source file or another file accessible by the device's executable instructions) retrievable context-specific information, retrievable merely by selecting terms, words, or phrases (i.e., without necessarily needing to type in text or select any additional instructions), and which context-specific information is information relevant to contextual understanding the piece being read. Likewise, enhanced e-book readers of the present invention include the software, hardware, executable instructions, memory, and other implementation technology as modified by means known in the art to provide a human reader the option to access electronically accessible context-specific information when reading from an enhanced e-book reader of the present invention.

Thus, by “context-specific information” is meant information generated or tailored to inform a human reader with respect to a term, word, or phrase within a specific context in the reading material. Human-reader selectable information on characters in a novel, information on places in a novel, tailored information on people or places in non-fiction works, and tailored definitions or standard translations can each be non-limiting examples of context-specific information. By “tailored” is meant altered from standard or general content (such as a full, plug-in standard dictionary) to a form having intended relevance to the piece being read by a human reader. Thus, standard dictionary entries providing multiple word meanings are not context-specific information, but a definition of a term can be context-specific information if the definition provided to the human reader upon selecting the term is tailored from a comprehensive standard dictionary entry to reflect a definition relevant to the use or sense of the term in context of the reading material, or is a translation of the selected term. Information displayed on-screen upon a human reader's selecting a name of a fictional person or place in a novel, for example, can be context-specific information and can be selectable by a human reader using an enhanced e-book reader of the present invention displaying an enhanced e-book of the present invention.

By way of non-limiting example of one aspect of the present invention, an enhanced e-book reader of the present invention displaying to a human reader an enhanced e-book fictional novel is described. A novel often involves many characters, scenes, places, and plot lines. A human reader reading such a novel may forget, for example, who certain characters are or the significance of certain places. Especially in a long novel, there may be many pages between mentions of certain people or places. In a paper-based book, the reader can “flip” back to find a mention of a character, for example, but in an e-book “flipping” is cumbersome. Using “back” buttons, or a search feature and a mini-keyboard make the equivalent of “flipping pages” burdensome. In the enhanced e-book of the present invention, however, the problem is solved by providing context-specific information about people and places simply by selecting the names on screen. For example, if the character John is married to Lisa, and was responsible for the death of son Tom during the depression, upon coming across the name John (the first time, or in one embodiment, at least for the second or subsequent time) in the enhanced e-book a human reader can select the word “John” by touch, hover, or cursor, and on-screen context-specific information about John can appear. For example, a “bubble” like a dialog bubble can appear on screen displaying, “John, husband to Lisa and Tom's father. Recall that John is responsible for Tom's death when they lived in Kansas during the depression.”

Context-specific information can be added by the author of the piece, for example, by a novel's author. Context-specific information can also be reader-generated. Context-specific information can be stored in an e-book's source file, or it can be stored electronically in a remote (either in the enhanced e-book reader's memory, or accessible online via the internet) look-up file, such as an enhanced e-book-retrievable database having fields corresponding to terms and context-specific information. An enhanced e-book of the present invention can include electronically stored information in any readable format, and can store context-specific information in any retrievable manner in any readable format. An enhanced e-book reader of the present invention can display machine-readable electronic files of an enhanced e-book in the same manner as do current e-book readers for current e-books.

In one sense context-specific information, whether in a work of fiction or nonfiction, can be considered to be information relevant to a person, place, or thing, which information, while not necessary to make explicit in the work, nevertheless enhances a human reader's enjoyment of the work, either by offering a reminder to a human reader of information the reader “knows” from earlier reading in the work but forgot, or providing information that the human reader may not know, which, if known, would enhance the human reader's understanding of a work's full intent and meaning. Thus, context-specific information is tailored to a work, and is not mere definitional, encyclopedic, or generic.

In addition to providing reminders to human readers of characters and their relationship to the storyline, places can also have such helpful guidance. For example, in a piece in which a place is mentioned more than once, upon reading the place name the first time, or, in an embodiment, at least at the second or subsequent mention, the human reader can select the name on screen and a helpful prompt can appear with context-specific information about the place in relation to the piece. For example, in a novel a reader can come across the place name “Great Falls” (which may or may not be a real-life place). Upon selecting the word on screen, further on-screen context-specific information can appear informing the reader, “Recall that this is where Lisa is from, and her father still lives there. John vowed never to go back.” In this manner the human reader is reminded of the relationship and significance of a place to a story's plotline.

Of course, an enhanced e-book can be fiction, non-fiction, reference, factual, and can be an electronic e-book source-file version of a traditional book, magazine, newspaper, blog, or other form. Context-specific information can relate to fictional people and places as well as actual people and places. A journalist writing in an online newspaper, or an online blog might, for example, wish to augment a story with context-specific information generated specifically for the context of the online story (as opposed to “canned” or generic links to people and place names, as is currently utilized in online journalism). Thus, a political writer may, in a story about US Presidents and their flaws mention President Clinton with selectable context-specific information displayable upon selection stating, “Recall President Clinton was impeached for his hands-on approach to Oval Office affairs.”

Enhanced e-books of the present invention offer a distinct advantage over both current e-books and traditional ink-and-paper books by offering to a human reader enhanced information content at the point of interest, while reading. This distinct difference over the current e-book technology can help drive increased sales of e-books (in the form of enhanced e-books), as well as e-book readers (in the form of enhanced e-book readers). Thus, the economic benefit to authors and enhanced e-book sellers can be significant, possibly reviving an interest in reading altogether.

Therefore, an enhanced e-book in an embodiment of the present invention differs from current e-books in that an enhanced e-book contains as part of its electronic source file (regardless of format) or as part of a separate electronic file retrievable by an enhanced e-book reader's executable instructions, context-specific information. Again, by context-specific information is meant information, such as definitions of terms, descriptions of places, and other information that is tailored in some respect to the enhanced e-book's context. Thus, if there are multiple definitions of a term, by selecting the term on screen, the human reader can be presented with the definition of the term as it is used in context. Likewise, if there are multiple descriptions of a place in a book, upon selecting a place name on screen, the reader can be provided with information about the place relevant to the context of the book. Thus, information on a character in a novel, such as Ahab in Moby Dick, can be embedded in a file associated with an enhanced e-book Moby Dick, such that upon selecting “Ahab” on screen, context-specific information appears about Ahab.

The context-specific information for a term, word, or phrase can be varied throughout the enhanced e-book. Using the example of Ahab in Moby Dick, as the human reader progresses through the enhanced e-book, the context-specific information that appears for Ahab can change with the changing story line, i.e., the changing context. Thus a reader can get context-specific information for a character, place, setting, scene, or story line that changes as the story line progresses, and which can be different the first, second, or subsequent times a particular term appears.

Context-specific information can be limited as desired for various embodiments of enhanced e-books and enhanced e-book readers. “Non-dictionary context-specific information” is context-specific information that does not include word definitions from pre-specified or default reference works in the language of the work (i.e., same-language definitions as opposed to translations into a second language). In an embodiment of an enhanced e-book context-specific information can be provided separate from a pre-specified or default dictionary (or any kind of dictionary), i.e., either in the absence of a dictionary or in addition to a dictionary. “Non-glossary context-specific information” is context-specific information that does not include pre-specified or default glossary entries. In an embodiment of an enhanced e-book context-specific information is provided separate from a glossary, i.e., either in the absence of a glossary or in addition to a glossary. “Variable context-specific information” is context-specific information that for at least one term, word, or phrase is varied in at least two separate entries for that same word, term, or phrase. Thus, if “John” is linked in one part of a novel to one entry stating “husband of Lisa” and in another part of the same novel as “brother of Bob”, the context-specific information is variable context-specific information.

In an embodiment a human reader touches the screen of an enhanced e-book reader and context-specific information appears on screen. That is, context-specific information is triggered by a single action of the user, which can be described as “one-click” or “one-touch”. The context-specific information can appear at the bottom of the screen and stay until the human reader “turns” the page. Or the context-specific information can appear and stay as long as the human reader is touching the touchscreen (or otherwise makes a selection). Or the context-specific information can appear and stay for a predetermined time period and then disappear. In another embodiment, rather than appear at the bottom of the screen, the context-specific information can appear in a “pop-up” window, or widget, or “speech bubble”-type window on screen. In one embodiment the context-specific information can be audibly presented to a human reader. Audible context-specific information can be in the form of voice-recorded audio files, or computer-generated voice output of text files.

In one embodiment, the context-specific information can have additional selections or links, each link being a hyperlink to other information accessible by touching the screen at the link (or selecting, or clicking, or the like, as known in the art for activating a hyperlink). For example, for a place name, a window of context-specific information can appear, and in that window (or elsewhere on the display screen) there can be additional links to information such as maps of the place, a history of the place, tourist attractions, and the like. Likewise, for a word, in addition to the context-specific definition the reader can be presented with additional selections for other information like a full definition, synonyms, thesaurus, other definitions, and the like.

Context-specific information for an enhanced e-book can be saved as part of the enhanced e-book electronic source file for utilization by system memory of an enhanced e-book reader, and associated through a data table with the respective terms, words, phrases, or sections of the enhanced e-book. For example, the name “John” in a novel can be associated with information in a database field designated “John”, with executable instructions to extract the database information and display it on screen upon selecting “John” on screen. Likewise, the database can have a field for “Page Number” (or location, or field, and the like) such that context-specific information for “John” is selected from the database based upon with page (or location, or field, and the like) the term “John” is selected. Other methods of electronic information storage and retrievable, as well as other methods of executable instructions in memory and software can be utilized, all is known in the art.

In an embodiment, therefore, an enhanced e-book can be prepared in a format suitable for an e-book reader such as the Sony PRS-700, equipped with a touchscreen and/or a stylus. Suitable formats include BBeB (LRF/LRX) and TXT, for example. To make the e-book an enhanced e-book, at least one term in the e-book is linked to context-specific information in an electronically accessible file in which such information is stored. The electronically accessible file can be a separate file stored in the system memory of the enhanced e-book reader, or it can be stored on a remote server and accessible via cable or wireless link, such as by internet access. Upon selecting this term, executable instructions stored in the e-book's system memory cause the stored information to be displayed on-screen by known methods of searching and retrieving. The style, placement and time-duration of the context-specific information can be adjusted as desired by methods known in the art.

Therefore, in an embodiment, the present invention can be described as an enhanced e-book, wherein the enhancement is in the inclusion in the e-book's source file or other accessible file of context-specific information. In an embodiment the invention can be described as an enhanced e-book, the enhanced e-book comprising a base work in an electronic source file readable by an enhanced e-book reader (such as, for example, BBeB (LRF/LRX), PDF, EPUB, TXT, RTF, JPG, BMP, GIF, PNG, MP3, AAC), which enhanced e-book can be a work of fiction, such as a novel, a work of non-fiction, such as a reference work, a work of journalism, such as an online newspaper, a blog entry, and the like, wherein the base work comprises at least one selectable term, which upon selection by a human reader there appears displayed on screen (or audibly) context-specific information relating to the selected term. Therefore, by “base work” is meant the underlying author-created work to which the enhanced features of the present invention can be beneficially combined.

In an embodiment, the context-specific information is non-dictionary context-specific information, that is, the context-specific information does not include generic dictionary definitions from pre-specified or default reference titles (as used in current e-book readers), but, for definitions can include tailored context-specific definitions, such definitions tailored to the use of the selected term in context, or translations into a language different from the base work. In an embodiment, the information provided upon selection of a term on screen is non-glossary context-specific information, that is, information that either varies with context throughout the base work for a given term, word, or phrase, or otherwise does not derive solely from a pre-specified or default glossary of terms.

In an embodiment the present invention can be described as an enhanced e-book reader for displaying enhanced e-books, the enhanced e-book reader having system memory and executable instructions for retrieving and displaying context-specific information from an enhanced e-book's source file (or a suitably accessible file) upon selection by a human reader of a term having such context-specific information associated therewith. The association can be by links to a portion of an enhanced e-book's source file, a companion file accessible by the source file, a look-up file, database fields, or the like, for example. In one embodiment, words, terms, or phrases having linked thereto context-specific information can be denoted as such by any suitable indicator, such as superscripted characters, underlining, highlighting, color variation, shading, or the like. In an embodiment terms, words, or phrases having associated therewith context-specific information can be denoted with a superscript “e”.

Embodiments of the invention are described with respect to certain non-limiting and exemplary features below. In the embodiment illustrated the base work is a fictional novel, but it is understood that the base work could be non-fiction, reference, journalistic, a blog entry, and the like.

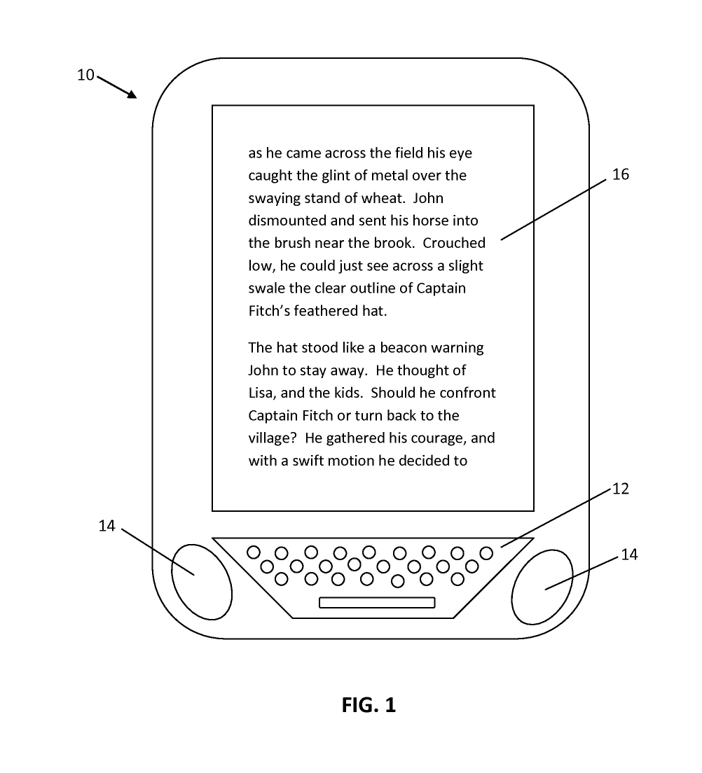

FIG. 1 shows an electronic device, which as exemplified herein is shown as enhanced e-book reader 10 and having certain features common to current e-book readers. E-book reader can be a dedicated e-book reader such as an Amazon Kindle®, or it can be an electronic device such as an Apple iPad useful for other features, but on which can be displayed e-books for reading by human readers.

While not shown in FIG. 1, it is understood that enhanced e-book reader 10 can have any and all of currently known technology, functions, and features of e-books, but for simplicity only certain features are illustrated. Enhanced e-book reader 10 can have a keyboard 12 for data entry, buttons 14 for functions such as page forward and back, and a screen 16 for displaying text, images, video, and the like, which screen can be a touchscreen. As shown in FIG. 1, the human reader can read on the screen 16 words of a base work, which is in this example a fictional novel.

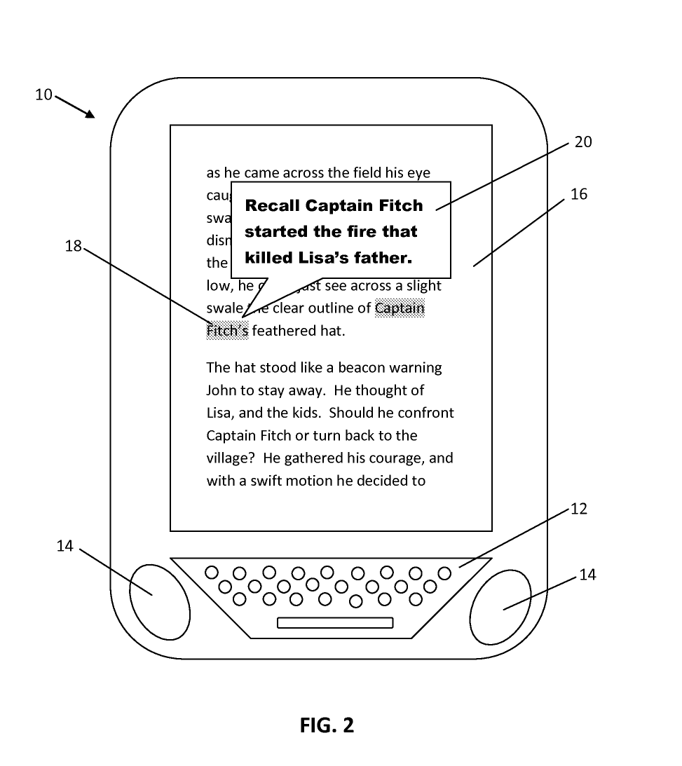

FIG. 2 shows enhanced e-book reader 10 as it can look once a human reader selects a term from an enhanced e-book, shown as shaded term 18, to have displayed context-specific information. Selected term 18 can be selected a single-action touch or tap, or a double tap, on touchscreen-enabled e-book readers, or by cursor movement, directional pad selection, keyboard, or other means. Selected term 18 can be modified after selection to look different, such as by highlighting, underline, or other means known in the art to indicate a term has been selected. As used herein, selected term 18 is referred to as “highlighted” to indicate a change in background shading in the vicinity of the term, as is commonly known in the art of text on computerized devices. But any kind of differentiating color, underline, font, bold text, or other indication can be used.

In an embodiment, once selected, executable instructions in the memory of the enhanced e-book reader can instruct retrieval from a file of context-specific information the context-specific information for the selected term. In one embodiment, each selectable term has associated therewith a code, which can be a unique code, which code can be used to find in a look-up file or a database the desired context-specific information, which information is then caused by the enhanced e-book reader's executable instructions to be displayed on the screen of the enhanced e-book reader 10. In an embodiment, rather than being in a separate look-up or database file (or other separate file), context-specific information can be stored in the electronic file of the base work as “hidden” text, made visible upon selection, or alternatively, stored in the base electronic file as a footnote, the footnote made visible upon selection. In an embodiment selection of selected term 18 links via cable or wirelessly to internet-accessible sources for context-specific information. In an embodiment internet-accessible context-specific information can be reader-generated content.

In the example shown in FIG. 2, a window 20 opens showing context-specific information reminding the reader that it was Captain Fitch who started the fire that killed Lisa's father. If a long period of time, or many pages, had elapsed since the reader had read of Captain Fitch, such a reminder by way of context-specific information would enhance the reader's comprehension and enjoyment of the enhanced e-book. Thus, the context-specific information allows the reader to avoid having to “backspace” or “search” previous pages to refresh his or her memory on this topic. Window 20 can stay open and visible for a set period of time, or it can be open while term 18 is being selected, such as by being touched by a human reader. Likewise, window 20 can be formatted as desired, and shown in any portion of screen 16. Also, the context specific information shown in window 20 can be rendered audible to the human reader, either with or instead of the visible text shown in window 20.

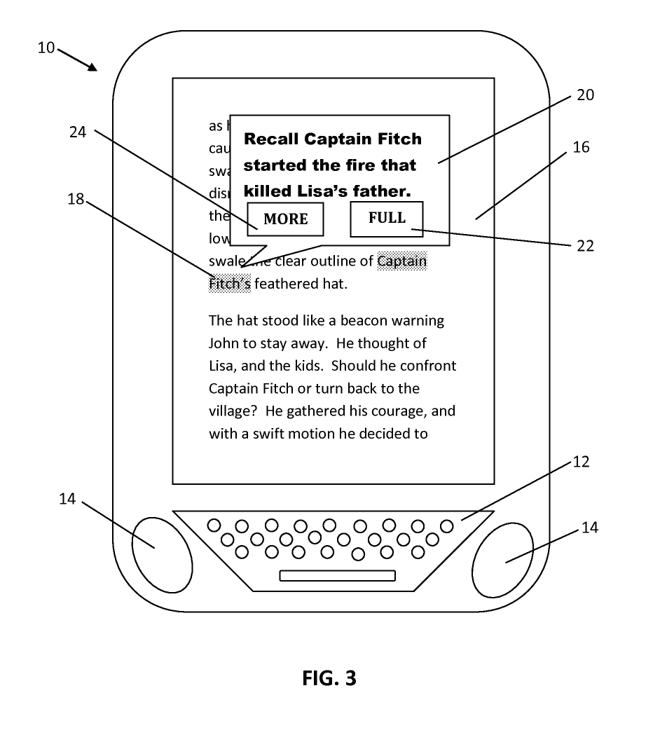

In an embodiment, as shown in FIG. 3, the context-specific information can be augmented with additional information. As shown, window 20 not only can display context-specific information, but can provide further second-level options, in this case two, for the human reader. The human reader can select, such as by touching, stylus, cursor, and the like, the second-level “MORE” button 24 for a additional context-specific information, and/or the second-level “FULL” button 22 to get all the context-specific information relating to the selected term. The “MORE” feature, for example, might provide the human reader with additional context around Lisa's father, the impact of the fire, and why this information is important to this point in the storyline. The “FULL” feature, for example, could give full biographic information on Captain Fitch, Lisa, and her father, as well as historic information on how the characters relate. Of course, in like manner the enhanced e-book can have third- and fourth-level options, and so forth.

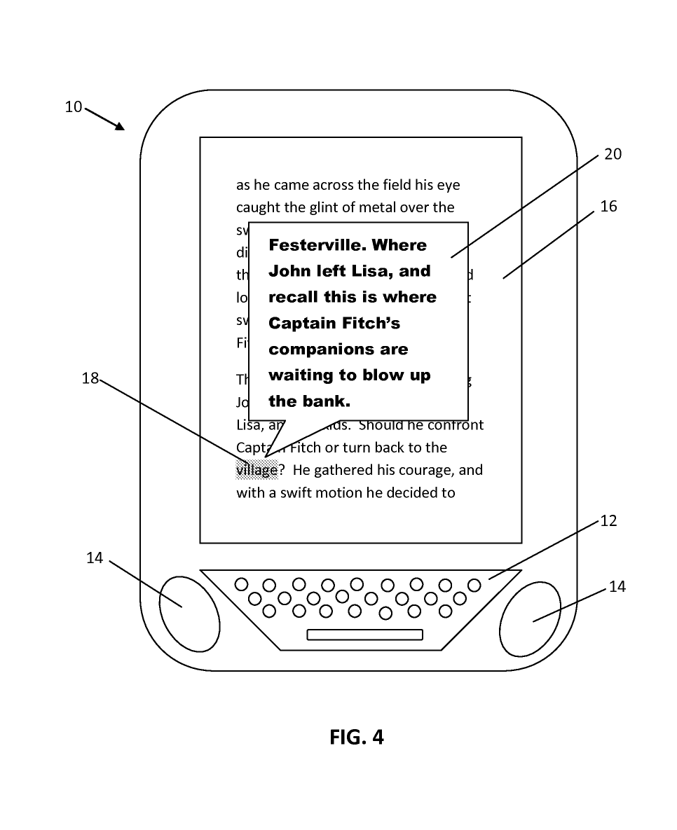

As shown in FIG. 4, context-specific information can be displayed for places in a novel as well. In the example of FIG. 4, a human reader has selected by touchscreen, cursor, or other means, the term 18 “village”. Window 20 appears displaying therein context-specific information about the village. As with the example shown in FIG. 3, window 20 in FIG. 4 could also be formatted to offer other selections, such as “MORE” or “FULL”.

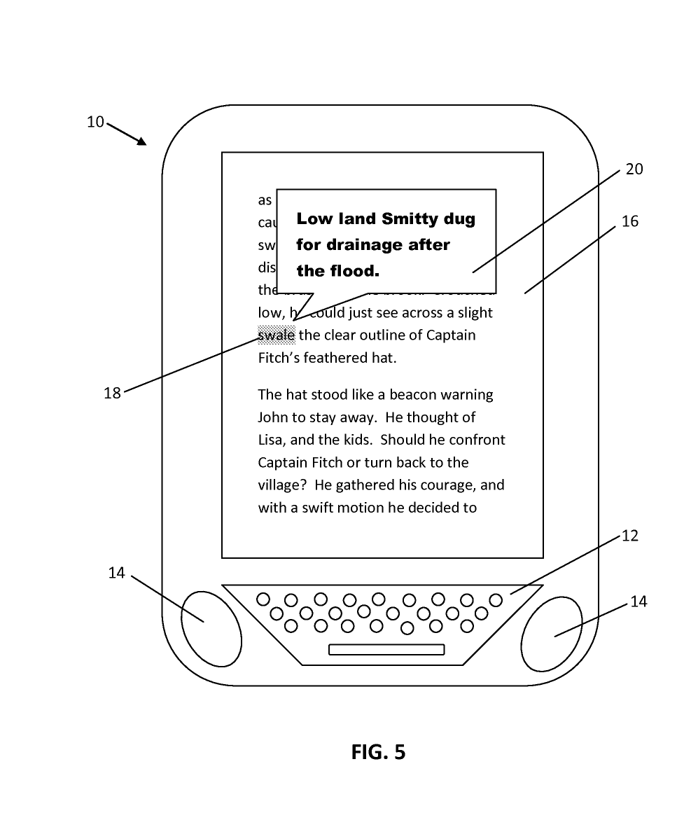

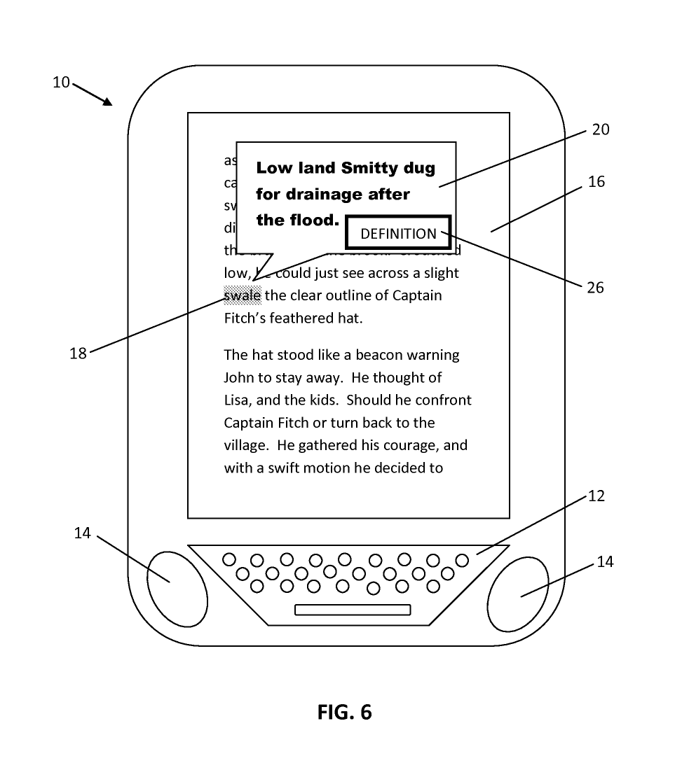

A shown in FIG. 5, context-specific information can be displayed for things in a novel as well. In the example of FIG. 5, a human reader has selected by touchscreen, cursor, or other means, the term 18 “swale”. Window 20 appears displaying therein context-specific information about the swale, as it relates to the story line. As with the example shown in FIG. 3, window 20 in FIG. 4 could also be formatted to offer other second- or third-level options with selections such as “MORE” or “FULL”. Likewise, for certain terms, as shown in FIG. 6, a human reader can be presented with second-level option for a definition. The definition supplied can itself be context-specific, or it can be a standard dictionary definition. Other second- and third-level options can be provided, such as for synonyms, antonyms, and the like.

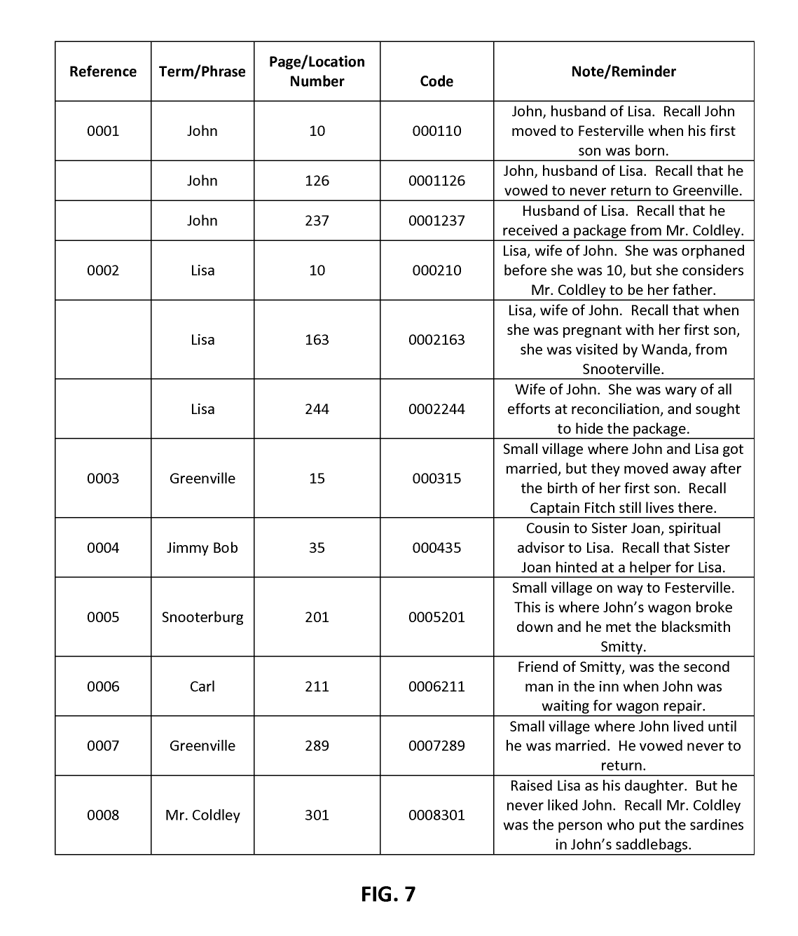

FIG. 7 shows one embodiment of a look-up table or database which in a text file or other suitably accessible source file can serve as the electronic repository for context-specific information, and which can be linked electronically to an e-book to make an enhanced e-book of the present invention. Linking can be by being a unitary part of the enhanced e-book's source file, or by a remote file residing on the enhanced e-book reader's system memory, or by link to a remote server file via wireless internet connection. Terms for which context-specific information is available can be identified by a code. In an embodiment, as shown in FIG. 7, the code can be a unique code and can be, for example, composed of a Reference number for a term, and a page/location on which an instance of the term appears. Thus, if the term “John” has a Reference number of “0001” and appears on page/location 10 of the base work, the code for accessing context-specific information can be “000110”. The term “page/location” is used to denote any method for identifying where in a base work a given term appears. Recognizing that “page numbers” can be ambiguous in an e-book, a “location” as used in current Amazon Kindle® e-books, for example, or “field” or other locator can be used.

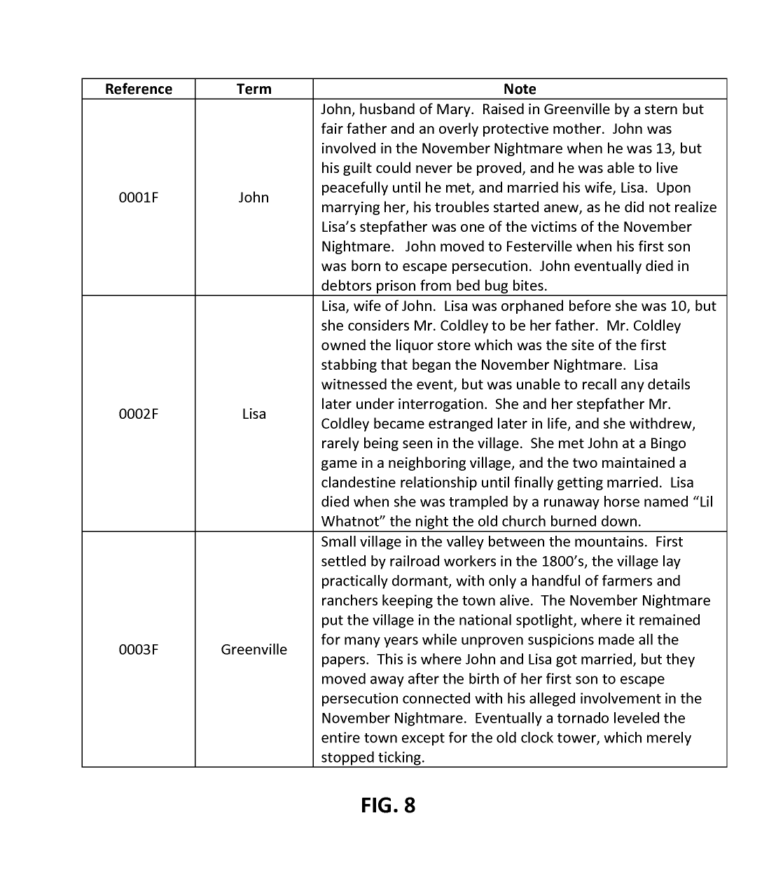

The table illustrated in FIG. 7 shows an example of “variable context-specific information”. As shown, a given term such as “John” has variable information depending on what location a particular selected term appears. FIG. 8 illustrates an example of a look-up table or database of context-specific information that can be used, for example, for “MORE” or “FULL” second-level options for other selectable terms.

In an embodiment the present invention includes a method of making an enhanced e-book, the method comprising the steps of making a source file for an e-book either via e-book writing software such as E-book Generator, Activ E-book Compiler, e-book Maestro, Adobe Acrobat, Desktop Author, E-book Pro, or other e-book writer/compiler, or by converting a text version of an existing book into an e-book via such software. Once converted, the method comprises denoting at least one term, word, or phrase as selectable for context-specific information and linking this term, word, or phrase to a source of context-specific information. The source for context-specific information can be embedded in the enhanced e-book's source file in a retrievable location and denoted by a suitable locator such as by a code, or it can be placed in a remote accessible look-up table or database retrievable by suitable executable instructions of the enhanced e-book reader's system memory operating from the enhanced e-book's source file.

In another aspect of the present invention, in addition to, or instead of, any combination of the above features, an enhanced e-book of the present invention can have an improved search feature that allows a reader of the enhanced e-book to find context-relevant information from within the base work. Context-relevant information is distinguished from context-specific information in that whereas context-specific information is supplemental information created to supplement a base work, and added to a base work to provide memory-refreshing information, context-relevant information is information contained in the base work source file itself as an integral part of the work itself, and not information added to explain, remind, or otherwise supplement a base work. Context-relevant information, therefore, is information created as a part of the base work, such as the text of an e-book source file created by the author of the work, and the whole of which can constitute the work itself. Examples of various exemplary features, structures, and benefits of an improved search feature for enhanced e-books are disclosed below. For the purposes of the present invention, the improved search features, structures, and benefits are referred to herein as “enhanced searching”.

Enhanced searching provides several benefits over known searching features in current e-book readers. First, in an embodiment, context-relevant information can be searched without the reader needing to type any text into a search field. Second, in an embodiment, a context-relevant search can be easily augmented with Boolean operators to target specific information, such as information a reader vaguely remembers, but wishes to be reminded of more fully. Third, in an embodiment, enhanced searching permits a reader of an enhanced e-book to follow terms back in a “tree diagram” fashion, and at each stage have the option of being easily brought back to the “last page read”, i.e., the place in the enhanced e-book where the reader left off to search a term. These and many other advantages can be enjoyed by a reader reading an enhanced e-book having enhanced search features of the present invention.

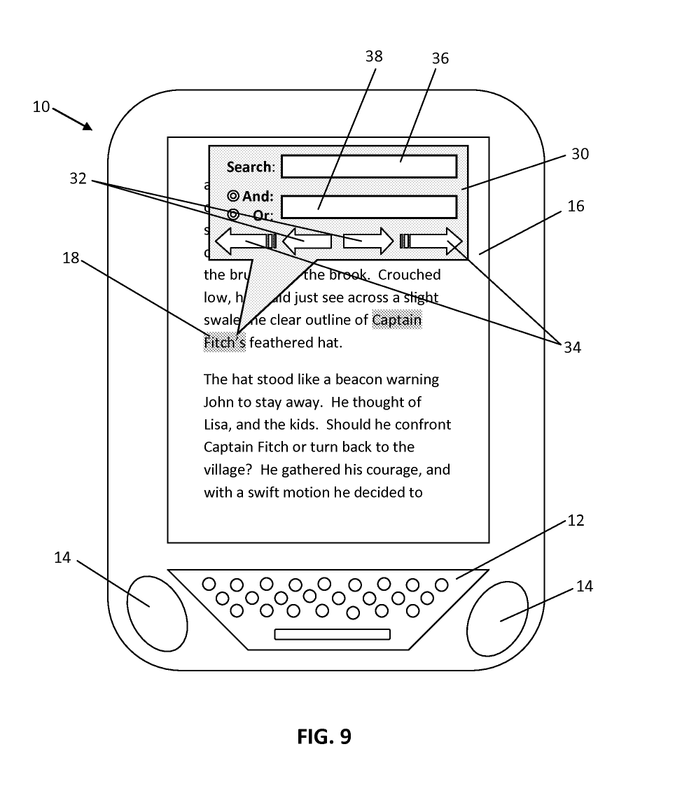

In an embodiment, as shown in FIG. 9, a human reader wishing to refresh her memory about a particular term in a first portion of an e-book can select the term 18, such as the term “Captain Fitch's” as shown in FIG. 9. As discussed above, once selected, selected term 18 can be shown by highlighting, underlining, or by other differentiating means. Once selected, the human reader can be presented with a display screen 16 showing additional selectable buttons, icons, images, or the like. For example, back and forward search buttons 32 can initiate a search for a second portion of the e-book in which occur the previous or next instance, respectively, of the selected term 18, or, if the executable file is so configured, variations on the selected term 18. For example, using the term 18 illustrated in FIG. 9, enhanced searching can find the previous or next instance of the terms “Captain Fitch” or “Fitch”. While arrows 32 are illustrated for this feature, any button, icon, image, or other selectable feature can be utilized. For ease of disclosure, the term “icon” substitutes for all of the various known means for presenting a selectable feature on electronic displays. Therefore, an “icon” as used herein can be any of known “buttons” “radio buttons” GUI images, hyperlinks, links, touch points, and the like known in the art for initiating by a user of an electronic document a function.

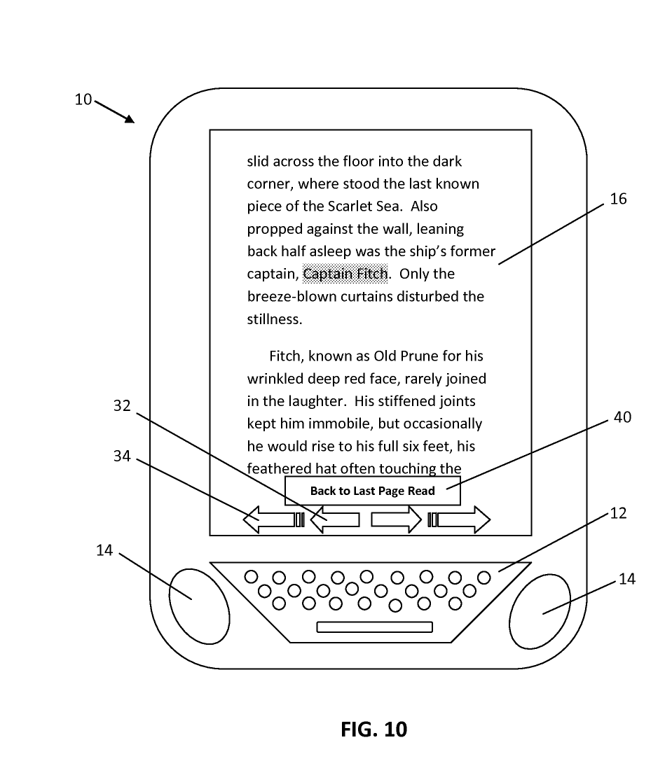

One advantage of the enhanced searching of an enhanced e-book of the present invention over known “search” or “find” functions is that the reader need not type anything into a search field. The reader merely touches, taps, or presses (if the e-book reader has a touchscreen) or otherwise selects back arrow 32 and is then presented with the portion of the e-book base work wherein the most recent previous mention of “Captain Fitch” occurred (as shown in FIG. 10, discussed below). Pressing back search button 32 (shown in FIG. 9 as the left-facing arrow 32) can be analogous to the laborious current method of typing in the name “Captain Fitch” into a search field and selecting an option of “searching up” or “previous” in the document. By merely pressing back arrow 32 (or forward arrow 32 as desired) the reader is spared the task of tediously typing in information using the relatively small keyboard 12 found on e-book readers.

If a reader wishes to see the very first or very last occurrence of selected term 18 in a first portion of an electronic document, she can select full back or full front arrow 34, respectively. In each case, upon selecting one of the full back or full front arrows 34, the reader is presented with a second portion of the e-book at which the first or last, respectively, mention of the selected term 18 occurs. Any other of known shapes, images, or icons can be utilized with, or instead of, arrows 32 and 34. Likewise, other search or find functionality can be implemented as is known in the art to further augment the enhanced searching feature of the present invention.

In an embodiment, the second portion of the electronic document can be shown on the display screen with the first portion, such as in a split-screen format. In this manner the human reader can see both the first and second portions on the same display screen.

In an embodiment, the invention can be described as an electronic device with an enhanced search capability, the electronic device having executable instructions in device memory and a human-readable display, the device comprising in the memory an electronic source file of an electronic document, the electronic document comprising at least one searchable term and a search function icon displayable upon the display screen, the searchable term at least appearing in a first portion of the electronic document, the searchable term being selectable by a human reader without the human reader manually entering in, such as by typing text into a search field, the searchable term and wherein upon selection by the human reader of the searchable term and subsequently selecting the search function icon, the executable instructions cause to be displayed on the display screen a second portion of the electronic document wherein the searchable term occurs. In an embodiment the electronic document is an e-book and the electronic device is an e-book reader. In an embodiment the electronic document is a text file. In an embodiment the device is a tablet computer, such as an iPad® by Apple. In an embodiment the device is a handheld device such as a smart phone or an iPhone® or an iPod®.

In an embodiment, the invention can be described as an electronic document having an enhanced search feature, the electronic document displayable on a display screen of an electronic device by executable instructions in memory of the electronic device, the electronic document having at least one term searchable within, and wherein upon selection of the searchable term by a human reader, and without the human reader manually entering in, such as by typing text into a search field, the searchable term, the executable instructions cause to be displayed on the display screen another portion of the electronic document wherein the searchable term appears. In an embodiment the electronic document is an e-book and the electronic device is an e-book reader. In an embodiment the electronic document is a text file. In an embodiment the device is a tablet computer, such as an iPad® by Apple. In an embodiment the device is a handheld device such as a smart phone or an iPhone® or an iPod®.

In an embodiment, selected term 18 shown at a second portion of the electronic document can be highlighted, underlined, or otherwise indicated for easy identification by the human reader. In an embodiment in addition to highlighting (or otherwise indicating) selected term 18 at a second portion of an electronic document, executable instructions in memory of the electronic device can also cause “n” units to be highlighted as well, wherein “n”=a positive integer and units are selected from the group consisting of words, lines, and paragraphs. By highlighting additional words around the selected term 18, the reader can more quickly find the relevant context in which selected term 18 occurs at the second portion of the electronic document.

In an embodiment, selection for searching can be achieved audibly. A reader, rather than press one of arrows 32 or 34, instead simply speaks the term audibly, as well as any other designated terms, if any, and executable instructions in memory of the electronic device translate the audible expression of the reader into text of a searchable term, and cause to be displayed on the display screen another portion of the electronic document wherein the searchable term appears.

In an embodiment, as illustrated in FIG. 9, an enhanced search feature can have different, or additional, components. For example, a reader may wish not only to find other instances of selected term 18, but a second portion of the electronic document containing other terms the reader can recall are associated with term 18. For example, a reader may recall that at one time Captain Fitch was involved in a poker game in which he lost his peg leg to a tattooed woman. The reader can, in addition to selecting the term “Captain Fitch”, enter, such as by typing text into a search field 36, a secondary search term, such as, in this example, “poker” or “peg leg” or “tattoo”. The display can have a “search” or “find” or “execute” icon or the like to initiate the search, at which time executable instructions in memory of the electronic device can then cause to be displayed a second portion of the base work in which both terms occur. In an embodiment, a search algorithm can dictate where is found a second portion, such as where the first and second searchable terms appear within “n” word together (wherein “n”=a positive integer, and programmed into the executable instructions), thereby reminding the reader of the portion of the base work in which the terms appear in context.

In an embodiment, the invention can be described as an electronic device with an enhanced search capability, the electronic device having executable instructions in device memory and a human-readable display, the device comprising in the memory an electronic source file of an electronic document, the electronic document comprising first and second searchable terms, the first searchable term at a first portion of the electronic document being selectable by a human reader without the human reader manually entering in the first searchable term, and the second searchable term being selectable by a human reader, wherein upon selection by the human reader of the first and second searchable terms, the executable instructions cause to be displayed on the display screen a second portion of the electronic document wherein the first and second terms occur. In an embodiment the electronic document is an e-book and the electronic device is an e-book reader. In an embodiment the electronic document is a text file. In an embodiment the device is a tablet computer, such as an iPad® by Apple. In an embodiment the device is a handheld device such as a smart phone or an iPhone® or an iPod®.

In an embodiment, the invention can be described as an electronic document having an enhanced search feature, the electronic document displayable on a display screen of an electronic device by executable instructions in memory of the electronic device, the electronic document having at least two terms searchable within, and wherein upon selection of a first searchable term by a human reader, and without the human reader manually entering in, such as by typing text into a search field, the first searchable term, and additionally the human reader manually entering in, or otherwise selecting, a second searchable term, the executable instructions cause to be displayed on the display screen another portion of the electronic document wherein the first and second searchable terms occur. In an embodiment, a search algorithm dictates the first and second searchable terms appear within “n” units of each other (wherein “n” =a positive integer and “units” is selected from the group consisting of words, sentences, lines, paragraphs, pages, or chapters). In an embodiment, the human reader can select the value of “n”, and/or the nature of “units”. In an embodiment the electronic document is an e-book and the electronic device is an e-book reader. In an embodiment the electronic document is a text file. In an embodiment the device is a tablet computer, such as an iPad® by Apple. In an embodiment the device is a handheld device such as a smart phone or an iPhone® or an iPod®.

In an embodiment, in addition to, or instead of, the search field 36 illustrated in FIG. 9, executable instructions in memory of the electronic device be programmed to cause to be displayed a menu of secondary search terms, such as a drop-down menu, in which one or more secondary search terms associated with the selected term 18 can be presented to the human reader for further selection. For example, if the selected term 18 is “Captain Fitch's” as shown in FIG. 9, an algorithm in the executable instructions of the electronic device can determine a group of one or more secondary search terms that appear in context with a predetermined frequency in the work related to Captain Fitch. For example, the algorithm can be instructions to “find all terms appearing elsewhere in the electronic document (which “find” can be limited to either forward or back, or both) in a paragraph with the term ‘Captain Fitch’, less terms from a list of common terms such as and, the, it, etc.

Algorithms to find sections of context relevant information in an electronic work can be executed by executable instructions in the memory of an electronic device, and can be tailored for a desired computation speed and comprehensiveness, and can be based on the relevant context being a sentence, a paragraph, a page, or a defined number of words. For example, in one embodiment an algorithm can be programmed into electronically executable instructions for execution by device executable instructions, and can have the following steps: (1) receive human-reader-selected search term (such as selected term 18 in FIG. 9); (2) search (either backward, forward, or both, as determined by a human reader's choice) for all other instances of human-reader-selected search term; (3) determine all terms appearing within n-units of human-reader-selected search term, and store such terms as “potentially secondary context relevant terms” (wherein “n”=a positive integer and “units” is selected from the group consisting of words, sentences, lines, paragraphs, pages, or chapters); (4) rank order the frequency of all potentially secondary context relevant terms; (5) output for display on a display screen a list of secondary search terms based upon one of the criteria selected from, “n” most frequent terms less a predetermined set of terms such as the, it, an, a, and the like; “n” least frequent terms less a predetermined set of terms such as the, it, an, a, and the like; “n” most frequent nouns; “n” most frequent verbs; “n” most frequent verbs and nouns, “n” most frequent nouns and/or verbs associated with human-reader-selected term that do not appear with the same frequency with other terms, and combinations thereof (wherein “n”=a positive integer); and (6) display to a human reader the secondary search terms for selection, if desired, by a human reader. The secondary search terms can be presented to the reader in a “drop down” style menu, and can include a “scrolling” function, as is common on menus in modern computer devices.

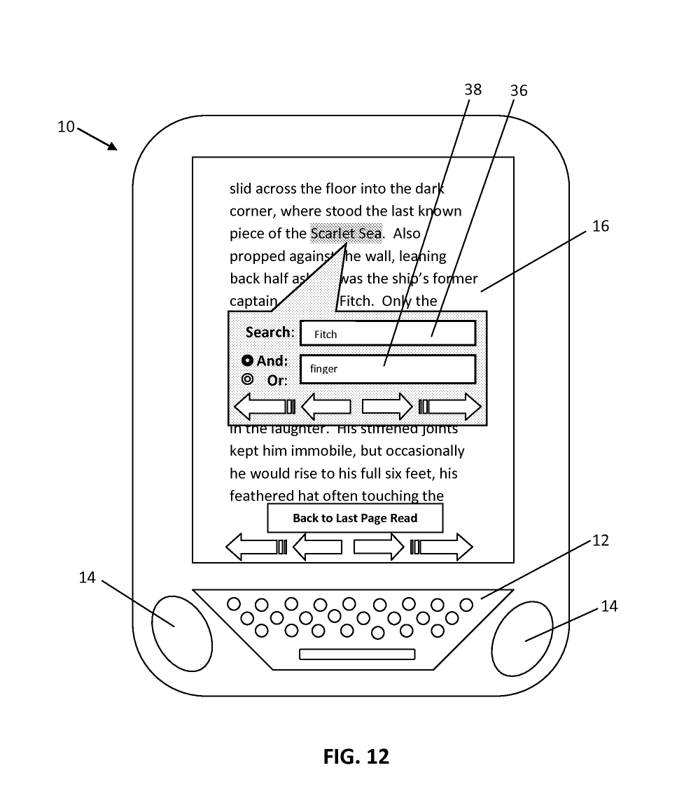

In an embodiment, enhanced searching can include a Boolean search field 38 selectable for search terms which can be entered by a human reader. Boolean search field 38 can have associated therewith selectable Boolean operators such as “and”, “or”, or “not”. Such searching is disclosed in more detail in the disclosure associated with FIG. 12, but in general Boolean search field 38 offers a human reader greater filtering search capability, especially when used in conjunction with search field 36. Boolean search field 38 can be set up in any suitable manner, and can be utilized in addition to, or instead of search field 36. For example, with respect to FIG. 9, if a human reader recalls Captain Fitch was in lots of bars, and lots of fights, but only one bar fight, the human reader can enter “bar” into search field 36 and “fight” into

Boolean search field 38, and select the “and” Boolean operator. Upon implementing such a search, executable instructions in the memory of the electronic device 10 can cause display 16 to display to the human reader a second portion of the base work electronic document in which all the selected terms appear as selected by an executable instruction algorithm, such as within n-units of the others (wherein “n”=a positive integer and “units” is selected from the group consisting of words, sentences, lines, paragraphs, pages, or chapters).

Upon selection of a term such as term 18 in FIG. 9, a human reader can benefit by being reminded of a particular term by being afforded easy access to the most recent previous occurrence of a term by selecting, for example, the back arrow 32, at which time the display can show a second portion of the electronic document in which the previous mention of the selected term appears, as illustrated in FIG. 10. FIG. 10 shows a representative portion of an electronic work, such as an e-book, which in this exemplary embodiment occurs before the portion illustrated in FIG. 9. As shown in FIG. 10, in addition to a second portion of the electronic work in which the term

“Captain Fitch” appears is displayed, display 16 can also display search arrows 32 and 34 for additional searching. Also, as shown in FIG. 10, the display 16 can have a selectable choice for the human reader to go back to where she left off reading, such as a “go back to last page read” selectable image, icon, button, 40 or the like. In one embodiment the “go back to last page read” choice can be labeled “Back” or it can be labeled “Return” or it can be labeled “Last” or other appropriate label, and can be activated by tapping or pressing an appropriate “button” on a touchscreen, or by manually scrolling with a cursor, or by audible signal.

In an embodiment, a human reader can perform additional searching in a branching “tree” format, where the reader can search from the first destination search screen (as shown in FIG. 10) to additional portions of the electronic work based on additional searching. For example, a human reader may, upon re-visiting the portion of a previously read part of an electronic work (as depicted in FIG. 10), notice another term, such as “ Scarlet Sea” in FIG. 10, that appears on the display in context with the displayed portion, and wish to be reminded of its context-relevant meaning.

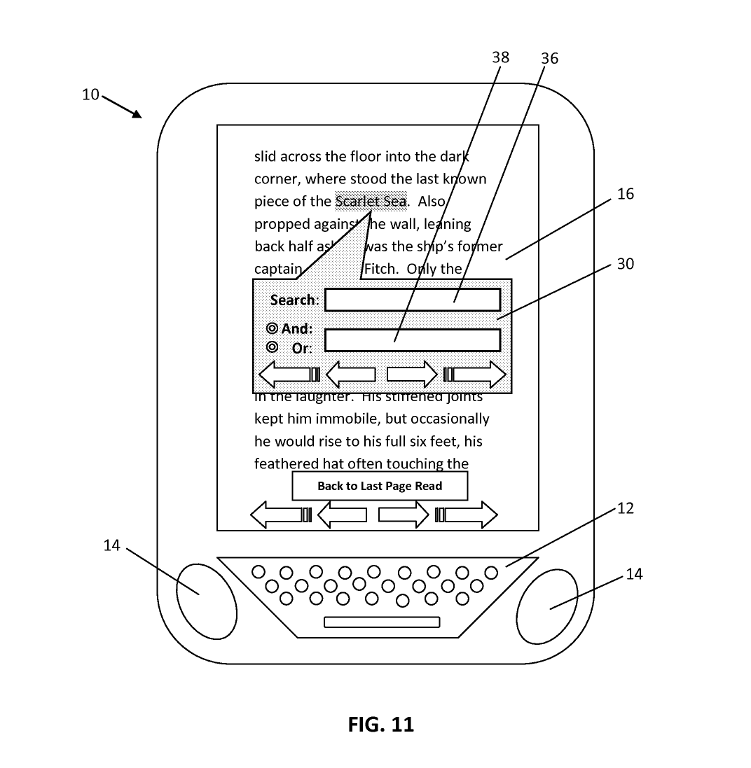

As shown in FIG. 11, a human reader can select the next term, such as “Scarlet Sea” in FIG. 11, to be presented with another opportunity to do searching as described above, i.e., via back or forward (e.g., by arrows 32 and 34), or by entering a secondary search term into search field 36, or Boolean search field 38. For example, as shown in FIG. 12, a human reader may recall that something significant occurred on the ship the Scarlet Sea involving Captain Fitch and a six-fingered pirate, whose name escapes the human reader. The human reader can enter into search field 36 the term “Fitch” and into Boolean search field 38 the term “finger” and select the Boolean operator “and”. In this manner, executable instructions in the memory of the device can cause to be displayed to the human reader a section of the electronic work in which the terms “Scarlet Sea”, “Fitch”, and “finger” each appear as selected by an executable instruction algorithm, such as selecting terms within n-units of the others (wherein “n” =a positive integer and “units” is selected from the group consisting of words, sentences, lines, paragraphs, pages, or chapters). In an embodiment, executable instructions in the memory of the electronic device default to “and” as an operator (or “or” or “not” etc), and search for occurrences of both terms if the human reader does not choose, or if not selection is available to a human reader.

In an embodiment the invention can be described as an electronic device having enhanced search capability, the electronic device having executable instructions in device memory and a human-readable display, the device comprising in the memory an electronic source file of an electronic document, the electronic document comprising first, second, and third searchable terms, the first searchable term at a first portion of the electronic document being selectable by a human reader without the human reader manually entering in the first searchable term, and the second and third searchable terms being related by a Boolean operator and selectable by the human reader, wherein upon selection by the human reader of the first, second, and third searchable terms, the executable instructions cause to be displayed on the display screen a second portion of the electronic document wherein the first, second, and third search terms occur. In an embodiment the electronic document is a text file. In an embodiment the device is a tablet computer, such as an iPad® by Apple. In an embodiment the device is a handheld device such as a smart phone or an iPhone® or an iPod®.

In an embodiment, the invention can be described as an electronic document having an enhanced search feature, the electronic document displayable on a display screen by executable instructions in memory of an electronic device, the electronic document having at least three terms searchable within, and wherein upon selection of a first searchable term by a human reader, and without the human reader manually entering in, such as by typing, the first searchable term, and additionally the human selecting, which can be by a human reader manually entering in text, a second and third searchable terms, the second and third searchable terms being related by a Boolean operator (which operator can be an implicit, default operator such as “and”, or can be chosen by the human reader), wherein the executable instructions cause to be displayed on the display screen another portion of the electronic document wherein the first, second and third searchable terms appear as selected by an executable instruction algorithm, such as within “n” units of each other (wherein “n”=a positive integer and “units” is selected from the group consisting of words, sentences, lines, paragraphs, pages, or chapters). In an embodiment the electronic document is an e-book and the electronic device is an e-book reader. In an embodiment the electronic document is a text file. In an embodiment the device is a tablet computer, such as an iPad® by Apple. In an embodiment the device is a handheld device such as a smart phone or an iPhone® or an iPod®.

In an embodiment an electronic device, such as an e-book reader, can have a touchscreen and can be programmed by executable instructions in memory thereof to permit a human reader to “hover” over a term onscreen, such as by placing fingertip close to the screen, or by pressing on the touchscreen, thereby producing context-specific information. Upon tapping, pressing harder, double tapping, or otherwise further selecting the selected term, the reader can be presented with context-relevant search features. Thus, an electronic document can be enhanced, and an electronic document reader can be enhanced by having capability of both context-specific information presentation, and context-relevant enhanced search capability.

In an embodiment, searching for previous or subsequent occurrences of terms can be achieved by any means known in the art for searching, including backward and forward word searching. Searching of multiple terms can be considered a filtering function, and can be termed a filtering feature.

In an embodiment, instead of simply displaying a screen of one instance of the searched-for terms, the display device can display a screen having all the instances of the searched-for terms. In one embodiment, for example, a reader of a medical journal may wish to filter a page of results based on the combination of the terms “lupus” and “children”. In this manner, a reader can “filter” out what could be voluminous information not relevant to a reader's interest.

In an embodiment an e-book can be augmented by executable instructions to be an enhanced e-book. For example, in an embodiment, a human reader utilizing an e-book reader on which is stored an e-book in a currently known format can input, such as, for example, by downloading via wireless internet connection, an application (commonly referred to as an “app”) an electronic file that modifies the e-book's source file to have capability to implement the various embodiments described herein to thereby convert an e-book into an enhanced e-book.

Thus, in an embodiment the invention can be described as a method for converting an e-book into an enhanced e-book, the method comprising providing an e-book reader having memory for storing e-book source files and executable instructions for displaying text on a display screen; providing an e-book in the memory of the e-book reader; downloading, via wireless connection or wired (e.g., USB) connection, an electronic file comprising executable instructions to modify or augment the source file and to modify executable instructions, if necessary, to execute on the e-book context-specific information and/or context-relevant enhanced searching features.

In an embodiment, the author, or another person, can select or “tag” certain terms to be secondary search terms associated with other, primary, search terms. Tagging can be by designating for storage in a suitable database field of one term that is intended to be associated with another term, so that when a first term is searched the other term can be displayed to the human reader as a secondary search term. In an embodiment, search terms can be submitted via the internet to a predetermined website by interested persons, and made available for download into a suitable executable file for augmenting e-books in order to convert them to enhanced e-books having an enhanced searching feature.

Thus, in an embodiment, the present invention can be described as a method for converting an e-book into an enhanced e-book, the method comprising, (1) providing an e-book reader having electronically executable instructions for storing in memory and displaying to a human reader a base work in an electronic source file readable by the e-book reader; (2) storing on the e-book reader a base work in an electronic source file (i.e., an e-book); downloading to the e-book an electronic file application having therein executable instructions for augmenting or modifying the base work with author- or reader- generated tags for search terms, the tagged terms incorporated in the executable instructions to provide the reader with enhanced searching features to convert an e-book into an enhanced e-book having enhanced searching capability.

Further, in an embodiment, the present invention can be described as a method for facilitating the conversion of an e-book into an enhanced e-book, the method comprising, (1) creating an electronic file application having therein executable instructions for augmenting or modifying a base work in an electronic source file readable by an e-book reader, the electronic source file having executable instructions to convert the e-book an enhanced e-book having enhanced searching capability; (2) making the electronic file available for download to e-book readers; (3) facilitating downloading the electronic file to e-book readers, after which the e-book reader is converted into an enhanced e-book reader having enhanced searching capability. In one embodiment the method includes instructions from the facilitator of the electronic file as to how to use the file.

In another aspect of the present invention, an electronic device, which can be an enhanced e-book reader, can be an educational device to aid a human reader in learning a language. In an embodiment the information displayed onscreen upon selection of text in a base work, can be a translation of a selected term, sentence, phrase, or the like. Thus, as described more fully below, in an embodiment a human reader of text on a screen of an electronic device such as a computer, laptop, iPad, smartphone, handheld web-enabled device, or e-book reader, can select a term in a first language, such as English, and the executable instructions in memory of the device can cause to be displayed on the screen a translation in a second language, such as Spanish. In an embodiment the translation can be a so-called “machine translation” as is known in the art and used on many current web-based translation tools, such as Yahoo!'s Babel Fish (http://babelfish.yahoo.com/) or Google Translate (http://translate.google.com/#), as well as many translation devices, such as those manufactured by ECTACO and sold at The Translator Store (http://www.thetranslatorstore.com/) or Franklin, sold at http://www.franklin.com/handhelds/translators/.

Machine translations can be achieved in the present invention by the executable instructions of the electronic device accessing, retrieving, and displaying a translation in the same manner as the aforementioned web-based translation tools or the aforementioned handheld translation devices. In an embodiment, the software, files, code, and executable instructions used in a device such as the Franklin TWE-118 can be resident in an electronic device of the present invention, such as an enhanced e-book, wherein selection of a term on the electronic device of the present invention replaces the analogous but cumbersome activity of typing in the term, as is done on known translation devices, and the translation is accessed, retrieved and displayed as the screen of an electronic device such as and e-book reader as it would be on a known translation device. The inventive advantage of the present invention, of course, is the incorporation of a translation tool in the contextual setting of a predetermined textual narrative, such the displayed text of an e-book, and the ability to select a term to have a translation appear without having to type out the term. In an embodiment a translation can appear upon a human user merely touching, tapping, or otherwise selecting a term with a single action, analogous to a “1-click” methodology.

In an embodiment, the translation can be based on a human-translated text. Thus, if an e-book published in a first language has a corresponding e-book published in a human-translated second language, the two versions can be correspondingly keyed to one another in their respective source files stored in memory on the device (or web-accessible), such that upon selection of a term, sentence, phrase, or the like by a human reader, the human-translated translation is displayed for viewing. For example, each term or sentence in the first text in a first language can be numbered consecutively, and upon selection of a term or sentence in the first text in a first language, executable instructions in the electronic device can search for the corresponding number in the second text in the second text, i.e., the translated version, and display it accordingly.

In the description below, the electronic device having translation capability is described in the context of an enhanced e-book, in which it is believed the educational language-learning opportunities are the greatest. However, the invention can be beneficial in traditional electronic devices, such as computers, laptops, Smartphones, iPhones, iPads, other handheld web-enabled devices, and the like by permitting the human reader to get a translation merely by selecting a term, sentence, phrase, or the like. That is, rather than using the known techniques, which require the user to type terms into a dedicated translation website, device, or the like, and which also requires the human reader to leave his present reading material in a disruptive exercise of entering text into a different translation means, the current invention permits the human reader to get a translation in context, on screen, and without leaving his present reading material. Thus, the present invention represents a different kind of translation means, specifically one which provides on-demand, on-screen, translation of selected terms in a predetermined primary reading text that can be an educationally beneficial textual narrative, and which does not require cumbersome secondary translation software or devices.

In one embodiment utilizing an electronic device that includes a pointing device, such as a mouse, the present invention can utilize typical mouse functions, such as a left button, or right button selection to initiate a translation. For example, in an embodiment having a mouse and executable software instructions for mouse operations, the executable instructions can include instructions to access a translation module in the memory of the device and retrieve and display a translated term, phrase, sentence, or the like, upon selection of the term, phrase, sentence, or the like, by use of the mouse. Use of the mouse can include use of dedicated buttons for translation, such as, in an embodiment, a third mouse button dedicated to use for holding in a known manner to make a selection, such as by “shading” text in known ways, at which time executable instructions can access, retrieve, and display a translation by means known in the art. For example, for web-enabled devices, the executable instructions can access Google Translate, retrieve a translation, and display the translation on the screen of the device. In another embodiment, the electronic device can have resident in memory machine translation software, such as is known on current dedicated translation devices, such as the aforementioned ECTACO or Franklin devices. Upon selection in the reading text, and without needing to separately or manually access a different device or software, executable instructions in the electronic device can access, retrieve, and display the translation in an identical manner as is currently utilized on dedicated handheld translators.

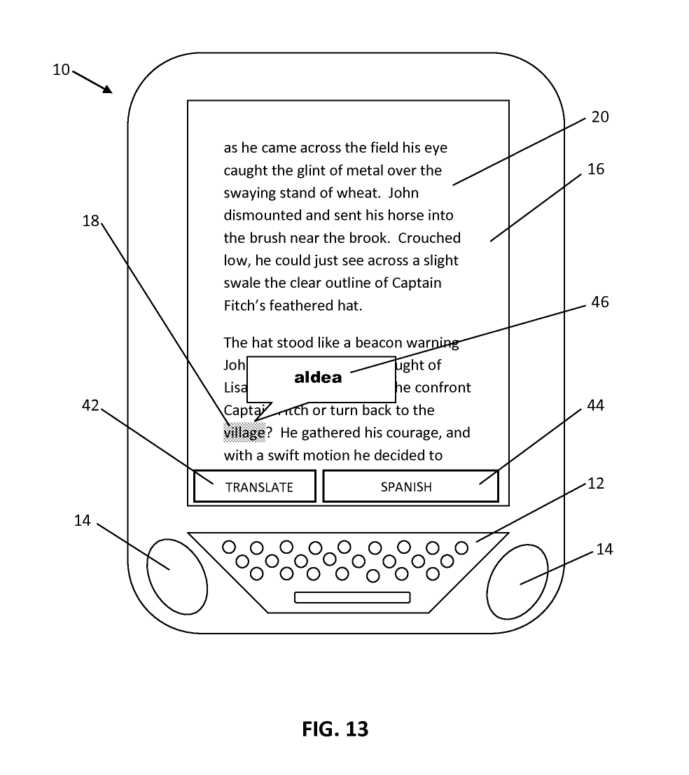

Referring to the Figures, in which an enhanced e-book reader is shown as a representative, but non-limiting, electronic device, an enhanced e-book reader 10 having an educational translation capability is described. FIG. 13 shows an embodiment in which a user reading in a first language, English, wishes to have translated into a second language, Spanish, a selected term 18. In this embodiment, a native Spanish-speaking reader may be reading an English-language version of an enhanced e-book in order to improve his English language skills. As he reads, he might understand most of what he reads, but he might come across a term, such as, in the illustrated case, “village” which he does not know. In an embodiment, the enhanced e-book 10 can have a default setting for translations, in which case upon selection of term 18 the executable instructions in memory automatically and virtually immediately can return the Spanish translation. In an embodiment, after a human reader selects the term “village” the enhanced e-book can present to him any of various selectable icons or “buttons” such as, for example, button 42 to select the translation function and button 44 to select which language to translate into. Button 44 can also incorporate a drop-down style menu selection in which the human reader can select from any of available languages to translate into. In the illustrated case in FIG. 13, the human reader has selected to translate into his mother tongue, Spanish, and a translation of the term “village” is shown as the Spanish translated term 46 “aldea”.

In a related embodiment, a human reader can read a base work in his native language, and choose to select terms to reveal their translation into a second language. In one embodiment, for example, a native Spanish reader can read a predetermined text of a base work in his native Spanish, and upon desiring to know the English translation of a term, select it for display of an English translation. In one embodiment, after selecting a term for translation, a human reader can choose to have all such terms in the base work be translated, in the same manner as the “replace all” function in popular word processing programs. In like manner, the executable instructions of the electronic device of the present invention can incorporate “find”, “next”, and “replace” functions as is known in the art of electronic word processing. By systematically replacing terms as they are learned, a reader can, over time, convert a base work in a first language into a translated work, or a substantially translated work, or a partially translated work, in a process of language learning.

Thus in an embodiment an enhanced e-book reader can be a device having executable instructions in device memory for displaying to a human reader a predetermined base work in a first language and options to translate a term upon selection by the human reader, and, optionally, to translate all such terms and their related forms (e.g., verb forms) into a second language. A method of using such a device can include the steps of providing an enhanced e-book reader having the above-mentioned capability; selection by a human reader of a term for translation by the methods disclosed herein, and either in the same step or in a separate step, selection by a human reader to translate all like terms in the predetermined base work; repeating the selection/translation steps for at least another, different, term in the predetermined base work; and optionally repeating the selection/translation steps until all the terms, or substantially all the terms, of the predetermined base work are translated. As can be appreciated, the enhanced e-book and method described above permit a human reader to gradually translate terms as he reads a predetermined base work, such a a novel or other meaningful narrative, with the gradual translation permitting the human reader to be educated in the new language.

The advantages of the present invention are evident from the illustrated embodiments, including the embodiment illustrated with respect to FIG. 13. Specifically, the human reader need not use a separate cumbersome device to translate, or even use a known paper and ink version of a translating dictionary. Moreover, the human reader need not type in a term for translating. The human reader merely selects, which can be by a one touch single action, and sees a translation on screen and in context. Another advantage of the invention for language learning is that the human reader can read in context, that is, in a meaningful narrative of a portion of text in which the translation appears together with context clues as to its meaning. The educational benefit provided by the present invention which allows a user to seamlessly see a translated term in real time and in context can hardly be overestimated.

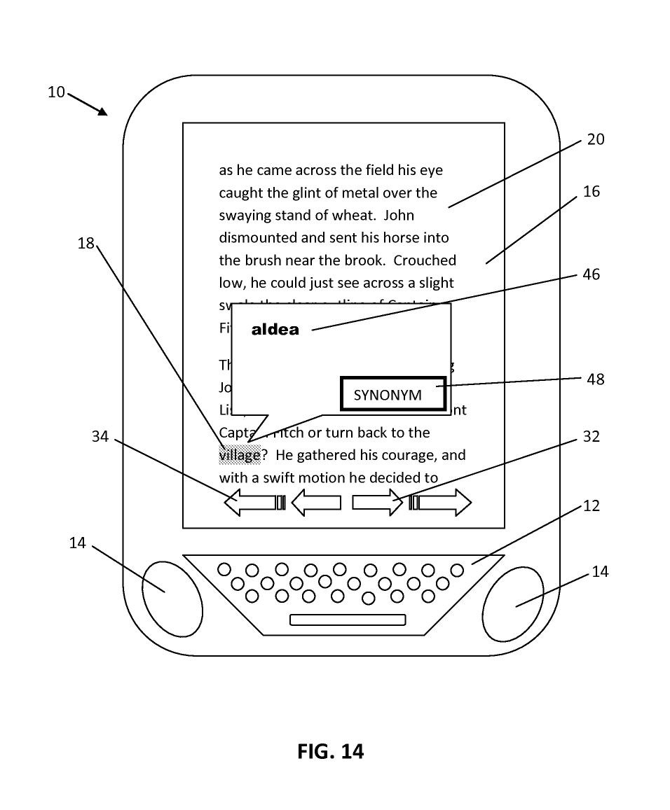

In an embodiment, a human reader looking at a translated term may have an idea that there is another word into which the first text can be translated. For example, in the illustrated embodiment, a reader whose first, or native, language is Spanish, and who is reading in English to improve his language skills, may suspect that the translated term 46 “aldea” is not the only or best translated term 46. In such a case, as is illustrated in FIG. 14, the electronic device, such as an enhanced e-book 10, can incorporate a “synonym” function. In an embodiment, in addition to (or instead of, or before) showing a first translated term 46, the device can show synonyms accessed, retrieved, and displayed from a file in the device memory. As illustrated, the human reader can be presented with a “synonym” button 48. Of course, any of various other functions, such as antonyms, homonyms, thesaurus entries, alternative spellings, and the like can be provided for in a like manner.

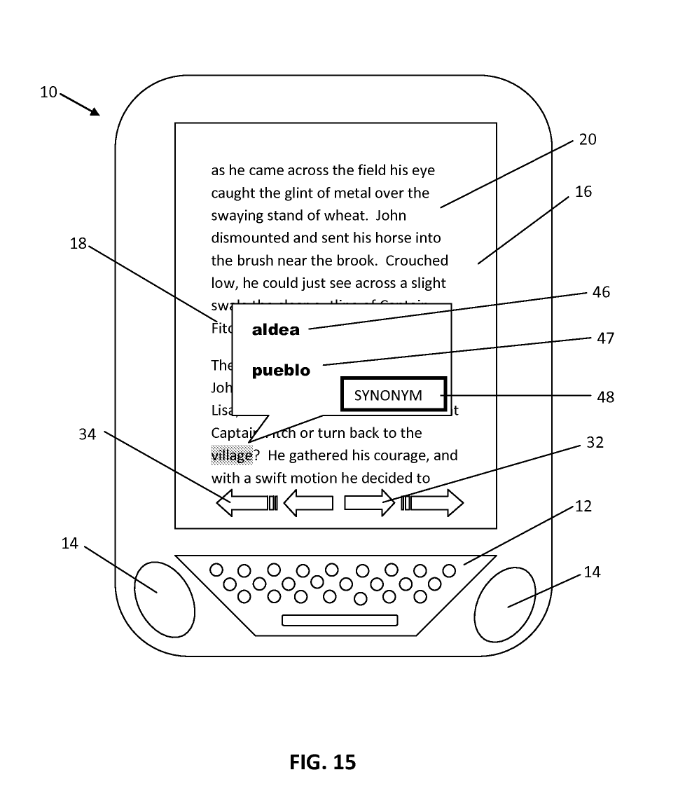

As shown in FIG. 15, upon selecting the “synonym” button 48, at least one synonym 47 can be shown with the original translated term 46. Once the human reader reads the translation, he can press any of known “escape” or “back” buttons or the like (not shown) to remove the translated terms and return to unobstructed reading of the primary, or base, text. Also, as shown in FIGS. 14 and 15, the onscreen display can include back and forward arrows 32 and 34 for further language learning in translation mode. For example, back or forward arrows 32 can search the enhanced e-book for the most recent previous use, or the next use, respectively, of the selected term 18. Likewise, the forward or back arrows 34 can be used to see the last, or first, respectively, use of the selected term 18. Of course, as described above with respect to arrows 32 and 34, any of various buttons, icons, images, or other selectable features can be utilized for the term search function. Also likewise, the search can be for a phrase, sentence, or other selected text. Thus, a reader wishing utilizing the enhanced e-book to learn a second language can see the same selected term 18 as it is used in various other contexts throughout the primary text.

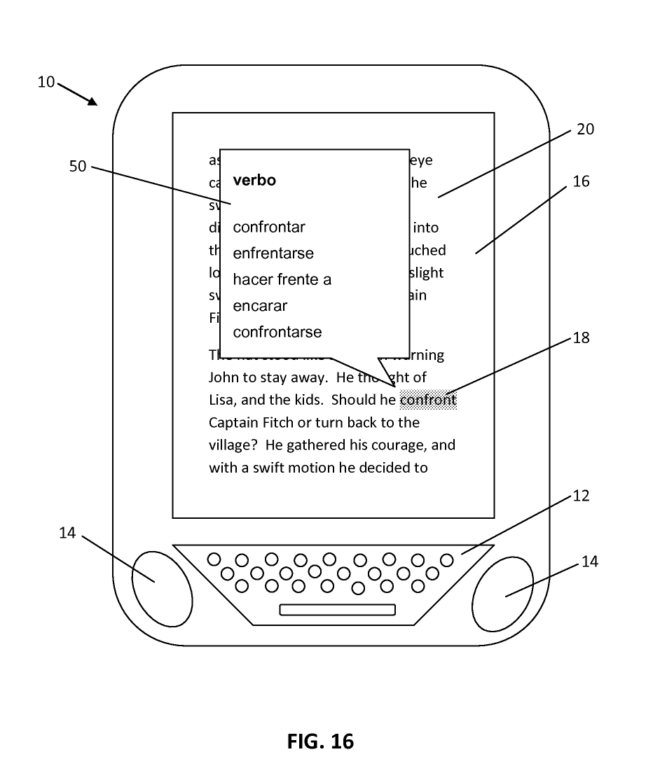

In an embodiment, a human reader may desire simply to see a typical dictionary translation of the various terms for which a term in a first language may be translated. For example, as shown in FIG. 16, upon selecting the selected term 18, executable instructions in the device, such as the illustrated enhanced e-book 10, cause to be accessed, retrieved and displayed a typical dictionary translation 50 of the term. As in all embodiments, access can be from a resident file in the device's memory, or from online access to a translation function from a web-enabled device.

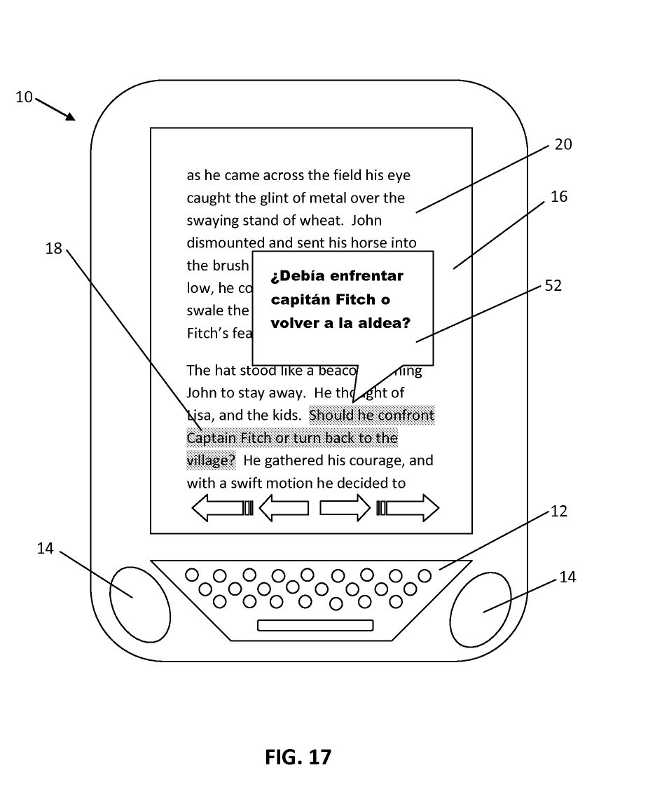

In an embodiment, a human reader may wish to see a translation of a complete sentence. For example, to use the illustrated example, a human reader may see the various translations of the selected term 18 “confront” and realize that the in-sentence context may dictate one translated term over another. Thus, in an embodiment, as illustrated in FIG. 17, the human reader can select an entire sentence 18 for translation, and the executable instructions in device memory can cause to be accessed, retrieved and displayed a translation 52 of the entire sentence. Again, the translation 52 can be a so-called “machine translation” as is known in the art and utilized by web-based translation services such as Babel Fish or Google Translate. However, in an embodiment, translation 52 can be a human-translated sentence provided in an accessible source file for access, retrievable and display.

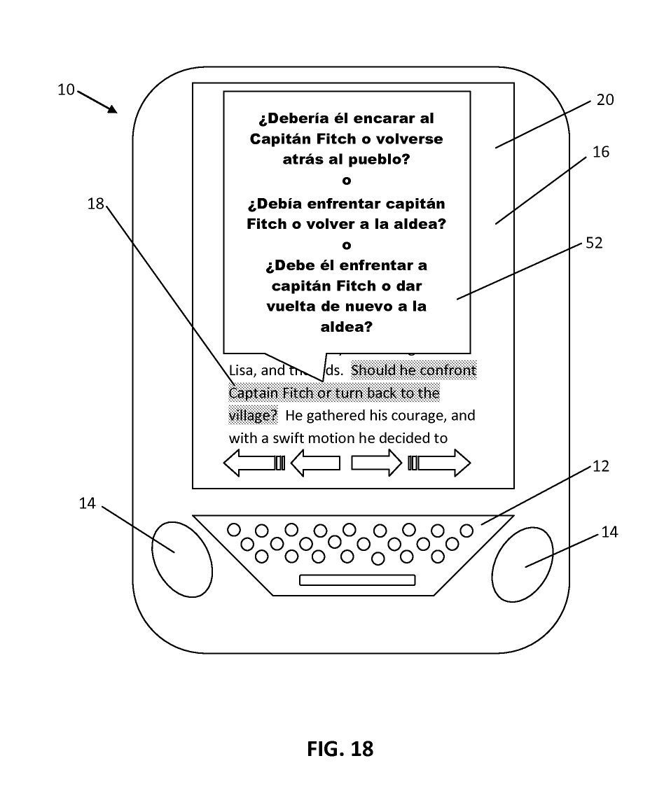

In an embodiment a reader wishing to improve his second language capability may wish to see other translations of the selected term or sentence 18. For example, a reader may suspect that a certain machine translation is not the best. Therefore, in an embodiment, as shown in FIG. 18, the electronic device of the present invention can provide for more than one translation, with each translation being from a different machine translation protocol. As shown in FIG. 18, for example, an enhanced e-book reader 10 of the present invention can show more than one different translation of the same sentence, each translated on a different web-based translation platform or protocol, and each differing in certain uses of terminology, such as the particular prepositions, nouns, and verb forms utilized for the English terms. In this manner, a human reader can appreciate subtle differences in translation, and can often glean a best translation of all the terms in context.

In a like manner entire paragraphs can be translated. In a like manner various other study aids can be implemented such as multiple language dictionary options, multiple language thesaurus options, audible translations, voice recognition and playback of translated terms, such as are known in the art. For example, the electronic device, such as an enhanced e-book reader can, upon selecting a term 18 utilize executable instructions to access, retrieve and generate an audible pronunciation of the selected term 18, by means known in the art.

In an embodiment the invention is an enhanced e-book reader having in memory an e-book source file and executable instructions for displaying first text in a first language from the source file on the enhanced e-book reader display, and as a separate but related source file, or in the same source file, a translated version of the first text into at least one second text which comprises at least one second language. In an embodiment, the translation is a machine translation. Translations tools, methods, systems, and software can be any as are known in the art, including those disclosed in U.S. Pat. No. 6,182,027, issued to Nasukawa et al. on Jan. 30, 2001; U.S. Pat. No. 6,876,963, issued to Miyahira et al. on Apr. 5, 2005; and, U.S. Pat. No. 7,359,849, issued to Palmquist on Apr. 15, 2008, each of which patents are hereby incorporated herein by reference for all their enabling teaching relating to electronic machine translation.

In an embodiment the translation is a human-translated version of the first text. A human-translated version of a work in a first language can be greatly beneficial to educational understanding by ensuring that subtle meanings are reflected and that idioms are correctly translated. An idiom is a word or expression whose meaning cannot be completely understood solely from the words used. Attempting to translate an idiomatic expression word for word, such as can happen with a machine translation, can result in confusion.

In an embodiment a current e-book reader can be made into an enhanced e-book reader by adding a translation module to the memory of the device. For example, translation software from LingvoSoft® (www.lingvosoft.com) can be downloaded via a wireless connection, or via a wired connection such as a USB cable, or otherwise loaded onto an electronic device for executable operation on the device. Once loaded, executable instructions in the electronic device can be programmed to detect a selected term, such as term 18, and enter it, like a typed in term, into the input for the translation software to translate, delivering it to the software for translation. Once translated, executable instructions in the memory of the electronic device can, by means known in the art, and per a desired format, return the translated output to the screen of the electronic device the translation.

A translation module comprising such features as the LingvoSoft® Translator can comprise all the software and hardware necessary to make a machine translation, and can comprise or consist of the necessary software and hardware as resides in current handheld translation devices such as the abovementioned ECTACO and Franklin devices, as well as any user interface instructions, as can be implemented as desired by means known in the art.

In an embodiment, the software and executable instructions of a an electronic device, such as an enhanced e-book reader, can comprise instructions to access the internet via a web-enabled device and use web-based technology to download a machine translation to the device from web-based tools such as the aforementioned Google Translate. In an embodiment, executable instructions detect a selected term, sentence, or phrase, optionally store the term, sentence, or phrase in memory, connect to a web-based translation site such as Google Translate, retrieve the selected term, sentence, or phrase (if previously stored) from memory and input it, or directly input it for translation, and, after being translated by the web-based translator, display the web-based translation output on the screen of the electronic device.

In an embodiment, an electronic device, including an enhanced e-book reader of the present invention, can have improved on-screen selection ability. When a touch screen is utilized, particularly on a small device, such as cellular telephone screen, an iPhone® or iPad-type device, and on e-book readers, it can be difficult to ensure that one's finger is actually selecting a desired term when pressing the touchscreen to make a selection. For example, for relatively large fingers and/or relatively small text, a finger tip can be covering multiple selectable units. By “selectable units” herein is meant any of terms, icons, links, or other selectable text or images displayed and configured for selection by pressing on a device's touchscreen.

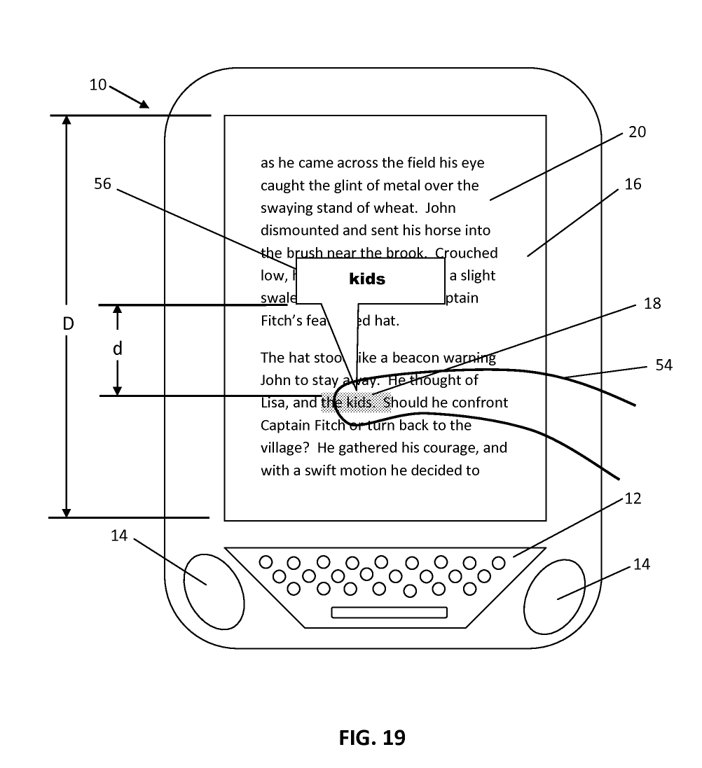

One known improvement for this problem is a TrueTouch Hover finger controlled touchscreens by Cypress Semiconductor, as reported 20 Apr. 2010 at www.cypress.com/?rID=42779. The TrueTouch Hover capacitive touchscreen provides hover detection, before the finger touches down. Hover detection can be non-contact hovering, and can also encompass some, such as slight, contact with a touchscreen, but not enough contact to constitute “pressing” or otherwise effecting a selection. Hover detection can allow the browser on a mobile phone, for example, to increase the font size of a selectable unit(s) as the finger approaches the screen. However, merely increasing the font size, or otherwise magnifying the image under a sensed fingertip, may not be sufficient for trouble-free accurate selection, as the fingertip can still block some or all of the text, and for relatively small text (or other selectable units), even the magnified text might be too small to effect proper selection. For this reason, an electronic device of the present invention, including iPad-like computer pad devices, mobile phones, and e-book readers, can implement an improvement of the present invention, as illustrated in FIG. 19.

As shown in FIG. 19, an improvement useful in electronic devices using touchscreen technology is an offset indication of a multi-digit selectable units (e.g., multi-number and/or multi-letter words) link to be selected. In the enhanced e-book example illustrated in FIG. 19, for example, a user using a touchscreen can use a finger 54 (shown diagrammatically and “transparently” to permit multi-letter words under finger to be seen) to select a selectable unit, such as a multi-letter term in an e-book, such as illustrated, the selected term 18 “kids”. Because the term is relatively short, and the text may be relatively small, a reader wishing to select the term may find that his or her finger covers the term, and, in fact, may be over the adjacent term “the” and/or the adjacent term “Should.” Even if hover detection and magnification technology is utilized, it can be that the magnified term desired to be selected is nevertheless blocked by the user's finger 54 or confounded by nearby selectable terms or images. For this reason, the electronic device of the present invention, including an enhanced e-book reader, can utilize the offset selection indication shown in FIG. 19.

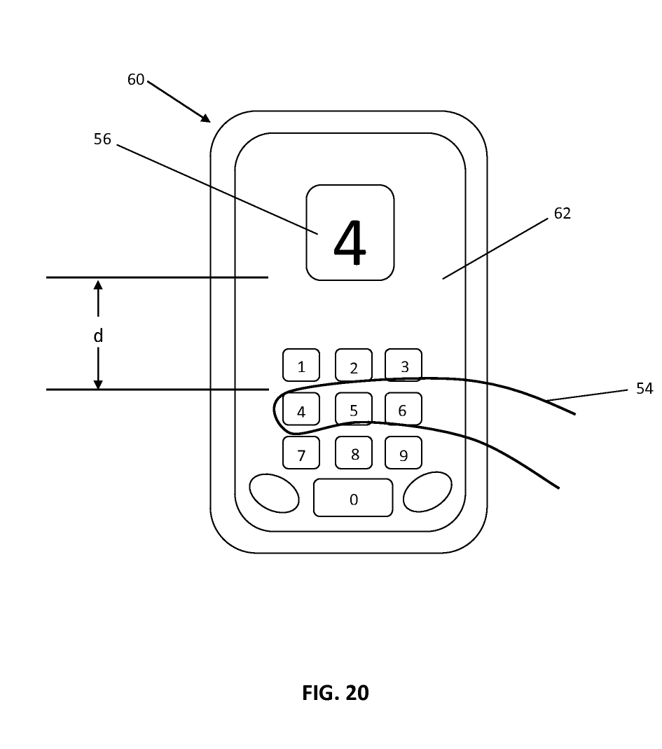

As shown in FIG. 19, a touchscreen 16 can utilize hover detection as is known in the art, such as TrueTouch Hover finger controlled touchscreens by Cypress Semiconductor and U.S. 2006/0022955, Ser. No. 10/927,925, entitled “Visual Expander”, filed Aug. 26, 2004, naming Kennedy; U.S. 2006/0132460, Ser. No. 11/018,679, entitled “Touch Screen Accuracy”, filed Dec. 22, 2004, naming Kolmykov-Zotov, et al.; U.S. 2006/0161871, Ser. No. 11/241,839, entitled “Proximity Detector in Handheld Device”, filed Sep. 30, 2005, in the name of Hotelling et al. It is known to make screens that can detect the proximity of a finger or thumb prior to actual pressing contact with the touchscreen, and in some cases modify the hovered-over area, such as enlarging or offsetting. But rather than merely exaggerate, magnify, or otherwise enlarge the hovered-over text at the location of the hovered-over text, executable instructions in device 10 (which is shown as an enhanced e-book reader, but could be any electronic device utilizing a touchscreen) causes a representation of the discrete selectable unit to appear in a separate, offset location, such as window 56 shown in FIG. 19. By representation is meant either an exact visual replica of the discrete selectable unit, or a modified but recognizable form of the discrete selectable unit. For example, as shown in FIG. 20, the numeral “4” in window 56 may be a different font, a different color, a different size, or have any of various other differences from the numeral “4” of the keypad, but it is a recognizable form of the keypad numeral “4.” In an embodiment, a discrete selectable unit is a complete word in the language of the e-book, as illustrated in FIG. 19.

The separate, offset location can have any desired configuration, as long as it shows a discrete selectable unit in a location remote from a user's finger or thumb, so that it is clearly visible and not blocked by the user's finger or thumb. In this manner, a user can look at, for example, window 56, and see what he or she is about to select if, instead of hovering, he or she contacts the touchscreen by pressing sufficiently to effect a selection. Remote location, such as window 56 can be a sufficient distance d to ensure adequate separation from a user's finger or thumb. In an embodiment d can equal about 12 mm, or about 18 mm, or about 25 mm or about 37 mm, or about 50 mm or about 100 mm, or any of 1 mm increments between any of the preceding distances, in any direction from the hover location. In an embodiment, d can be equal to from about 5% to about 90% and any 1% increment between, of a maximum length or width (whichever is greater) dimension D of touchscreen 16. In an embodiment, d can be a distance equal to about 10% or about 20% or about 30% or about 50% or about 60% or about 70% or about 80% of D.

As is clear from the discussion herein, an offset indication of a discrete selectable unit of text, imagery, icons, or other selectable units, permits a user to look at a screen location remote from that under his or her finger to see what it is he or she is about to select upon making sufficient pressing contact with the touchscreen. In an e-book execution, an offset indication of a discrete selectable unit of multi-letter text or multi-number text is particularly valuable, as a human reader is likely to wish to select an entire word or number, rather than, as with telephones, a single number or single letter. The executable instructions for effecting the offset indication can be implemented in any of known ways of effecting screen images. For example, the capacitive hover detection can detect a selectable unit closest in proximity to a user's finger tip and the executable instructions can effect a selection of a term, image, icon, or other discrete selectable unit closest to the closest proximity, and display a representation of the discrete selectable unit a distance d from the user's finger tip for easier viewing by the user.

Offset indication of discrete selectable units can be particularly valuable when dialing numbers on a mobile device capable of telephonic communication, such as a mobile telephone. FIG. 20 shows a typical mobile device 60 having mobile telephone functionality. Device 60 could be, or be similar to, an e-book reader, an iPad®, or an iPhone®, for example. Such mobile devices can display the telephone keypad as images for selecting by touching the touchscreen 62 over the desired number.

However, for relatively large fingers or thumbs, and/or relatively small numbers, the user's finger or thumb can block not only the desired number, but adjacent numbers, so that it is easy to inadvertently select a number adjacent the desired number. For example, in the illustration of FIG. 20, a user's finger 54 is over the number “4”, but the numbers “4”, “5” “6” and parts of “2” and “3” are blocked by finger 54.

The frustration of inadvertently selecting a wrong “key” on an onscreen telephone keypad can be minimized, if not eliminated by utilizing hover-detecting touchscreen, such as the TrueTouch Hover finger controlled touchscreens by Cypress Semiconductor with offset indication as disclosed herein. Thus, as shown in FIG. 20, a closest number in proximity to a users hovering finger or thumb tip can be displayed in a separate location, such as window 56, which, as disclosed above can be a distance d from the selectable number. In this manner, a user need look at only one location of screen 62 and merely move his or her finger or thumb about, selecting the desired number as it appears at remote, offset location, such as window 56. When the desired number appears in the offset location, such as window 56, the user presses the touchscreen to effect a selection. The process can then be repeated for the next number in a phone number, or any other function such as “send” or “end” without the user needing to look anywhere onscreen except at the offset location. Such a feature has not only convenience benefits, but safety benefits as many drivers attempt to dial while driving.

In another embodiment, an electronic device comprising a hover-detecting touchscreen can, instead of, or together with a corresponding visually perceptible representation of the hovered-over discrete selectable unit, executable instructions in device 10 or 62 can cause to be emitted a corresponding audibly perceptible representation of the discrete selectable unit. For example, using the embodiment shown in FIG. 20, mobile device 60 can be configured with a sound-emitting speaker that emits an audible “four” when a user's finger hovers closest over the number “4”. Thus a driver who attempts to dial phone number need not take his eyes off the road to effectively dial a phone number, enter a text message, or perform any of other known functions on a mobile telephone.

In an embodiment, after pressing to select a selectable unit that was represented in an offset location, or audibly as described above, the device can emit a confirming representation, either visibly or audibly. Thus, for example, in an embodiment, in after the device emits an audible representation of “four”, and the user presses the numeral “4”, the device can again emit the sound “four” in confirmation. In like manner, a confirming visible image can be displayed onscreen after pressing a selectable unit to confirm the selection.

Therefore, in an embodiment, the present invention can be described as an electronic device comprising a hover-detecting touchscreen, the device comprising memory and executable instructions in the memory for causing a discrete selectable unit to be displayed on the screen, and whereupon upon detection by the hover-detecting touchscreen of a hovering finger or thumb tip in the proximity of the discrete selectable unit, the executable instructions cause a visually or audibly perceptible representation of the discrete selectable unit to be displayed in an offset location of the touchscreen. In an embodiment, the device can further comprise executable instructions in memory to emit a confirmatory representation of the selectable unit, the confirmatory representation being either visible or audible. In an embodiment, the device is an e-book reader, an iPad®-like pad computing device, or the like, but differing from current technology in that the device also comprises telephone capability. For example, an e-book reader or iPad® device, or the like can have integrated into its software and hardware the technology present in an iPhone® or like device, thereby enabling a device so-equipped to not only serve as an e-book or tablet or pad computer, but also offer telephone functionality. In an embodiment, the e-book reader, tablet computer, or pad device has wireless functionality, such as that provided by Bluetooth® technology, so as to permit a person to utilize the device as a telephone without having to actually raise the device to his or her ear. All hardware and software can be combined into one device by means known to those skilled in the art, but heretofore overlooked because of the nonobvious nature of the combination. That is, both pad devices and telephones have long been known, but until now no one has discovered the synergistic benefit of putting the two together.

In an embodiment, an e-book reader of the present invention can be in every way configured as current e-book readers, but for one difference: the e-book reader can be configured for purposefully limited use. By “purposefully limited use” is meant limited use, such as predetermined limited time of use, that is predetermined and not due merely to “wearing out” or getting lost, or unintended malfunction or destruction. By way of example, disposable cameras are examples of devices having “purposefully limited use” as they are intended to be used for a predetermined limited time and then disposed of or recycled.

In one embodiment an e-book reader of the present invention can be disposable. By disposable is meant intended for purposefully limited, including one-time, use, the limitation on use being one of limited content or limited time, with the device being essentially useless as an e-book reader after the expiration of the predetermined content or predetermined time. For example, an e-book reader can be supplied with limited content, such as one complete e-book source file for displaying an e-book of finite length, and, after the e-book reader has displayed the limited content fully one time (or a predetermined number of times), the e-book reader is programmed, or the e-book source file is programmed, to prevent any additional viewing of the content. Of course, the e-book reader could be configured to permit one, two, or more viewings of the content, but the executable instructions of the e-book reader, or the source code of the e-book file would dictate a predetermined finite number of viewings of the content.

In another embodiment, an e-book reader can be configured for limited use, including as a disposable e-book reader, by limiting the time for which the content of an e-book source file can be viewed. The time can be considered as absolute, e.g., from the time of purchase, or relative, such as the actual time the screen of the e-book reader is active. Or the time can be dictated by the length of time of a single battery charge, or predetermined number of battery chargings. For example, the battery can be a non-rechargeable battery. Or the battery can be a non-replaceable battery. Or the battery can be “factory-rechargeable” or “factory replaceable”, that is, rechargeable or replaceable by methods, such as proprietary methods, requiring return to the “factory” or other authorized recharger/replacer. Or the battery can be a single use, non-rechargeable battery. In any event, after the predetermined time is expired the e-book reader can be disposed of. Disposal for disposable e-book readers can be by recycling, in a similar manner as disposable cameras are handled currently.

In another embodiment, an e-book reader can be configured for limited use, including as a disposable e-book reader, by limiting the amount or kind of memory available for e-book source file storage and display. In one embodiment an e-book reader can have substantially only enough memory for a predetermined intended e-book source file. In an embodiment an e-book reader can be supplied with content in memory, the e-book reader having no download or read/write capability to add content to memory or exchange content in memory. In an embodiment the e-book reader can have no non-volatile memory. In an embodiment an e-book reader can have no “flash” memory. Thus, an e-book reader can be dedicated to predetermined content.

Therefore, in one embodiment, an e-book reader of the present invention can be described as an e-book reader having a predetermined operative period, the predetermined operative period being defined by limited time or limited content, after which operative period expires the e-book reader no longer functions as an e-book reader. In an embodiment the predetermined operative period is less than one year. In an embodiment the predetermined operative period is less than six months. In an embodiment the predetermined operative period is less than three months. In an embodiment the predetermined operative period is less than one month. In an embodiment the predetermined operative period is less than 100 hours of time the screen is illuminated. In an embodiment the predetermined operative period is less than 50 hours of time the screen is illuminated. In an embodiment the predetermined operative period is less than 10 hours of time the screen is illuminated. In an embodiment the predetermined operative period is N times an installed battery charge, where N can be any integer between 1 and 100.

In another embodiment, an e-book reader of the present invention can be described as an e-book reader having stored in memory viewable content, the viewable content being viewable for a limited time not dictated by battery life, wherein after the limited time the content is no longer viewable on the e-book reader.

In another embodiment, an e-book reader of the present invention can be described as an e-book reader powered by a nonrechargeable battery.

In another embodiment, an e-book reader of the present invention can be described as an e-book reader powered by a factory-rechargeable battery.

In another embodiment, an e-book reader of the present invention can be described as an e-book reader powered by a factory-rechargeable battery or a factory-replaceable battery.

One benefit of an e-book reader having a predetermined operative period is the ability to control the electronic use of copyrighted material. For example, in schools, libraries, and other institutions where in the past traditional books have been used and then “turned in”, a limited operative period e-book reader permits electronic content to be viewed for a limited time without requiring that the e-book content be returned in the traditional manner. The user merely returns or disposes of the e-book reader, and the e-book content is likewise disposed of. Such e-book readers can be vended from vending machines, for example, such as in airports or hotel lobbies. A vended e-book reader can be a disposable e-book reader such that, like a paperback book, it can be simply discarded or recycled after use.

Thus, in an embodiment, the present invention can be described as a vending machine, the vending machine having inside for vending e-book readers, at least one of the e-book readers having, in addition to any, all, or none of the above mentioned features, a predetermined operative period. The vending machine can have and utilize any known operational technology as is known in the art for vending machines.

In an embodiment, the present invention can be described as a method of selling and/or dispensing e-book readers, the method comprising the steps of providing a vending machine configured for vending an e-book reader upon receipt of a correct monetary amount, and dispensing an e-book reader upon selection of the e-book by a user of the vending machine.

In an embodiment the invention can be described as an e-book reader, the e-book reader having a predetermined operative period, the operative period being defined by limited time or limited content, after which operative period expires the e-book reader no longer functions as an e-book reader.

In an embodiment, the invention can be described as an e-book reader, the e-book reader having stored in memory viewable content, the viewable content being viewable for a limited time not dictated by battery life, wherein after the limited time the content is no longer viewable on the e-book reader.

In an embodiment, the invention can be described as an e-book reader comprising a nonrechargeable battery and powered at least partially by the nonrechargeable battery. In one embodiment the battery is intended for single use.

In an embodiment, the invention can be described as an e-book reader comprising a factory-rechargeable battery and powered at least partially by the factory-rechargeable battery.

In an embodiment, the invention can be described as an e-book reader comprising a factory-replaceable battery and powered at least partially by the factory-replaceable battery.

In an embodiment, the invention can be described as an e-book reader comprising a nonrechargeable battery and powered solely by the nonrechargeable battery.

In an embodiment, the invention can be described as an e-book reader comprising a factory-rechargeable battery and powered solely by the factory-rechargeable battery.

In an embodiment, the invention can be described as an e-book reader comprising a factory-replaceable battery and powered solely by the factory-replaceable battery.

In an embodiment, the invention can be described as a disposable e-book reader.

In all cases of e-book readers of the present invention comprising a battery, the battery can be electrically and mechanically connected and located in the e-book reader in any manner desired, as is currently known and practiced in the art of e-book readers and other battery-powered electronic devices. For example, in some current electronic devices the battery can be user-accessed and user-replaced. In other current electronic devices the battery is inaccessible to the user and is either inaccessible or must be accessed by trained personnel. Either approach can be utilized in like manner as desired for e-book readers of the present invention.

In an embodiment, an e-book reader of the present invention can be in every way configured as current e-book readers, but for one difference: the e-book reader can have little or no internal memory. That is, the e-book reader can be a “dummy” reader, referred to herein as a “memoryless e-book reader”, that is incapable of storing an e-book source file in what is known as “internal memory” and is generally permanent internal memory. For example, current e-book readers have from 1-4 GB of permanent internal memory (distinguished from RAM for handling operational tasks). An e-book reader of the present invention can have less than 1 GB or less than 1 MB or less than 512 bytes of internal memory, and it can even have 0 MB of permanent internal memory for storing an e-book source file.

To compensate for having little or no internal memory for storing e-book source files, a memoryless e-book reader of the present invention can have a memory card slot that can accept a memory storage device, also called a memory card, such as a USB flash drive, a compact flash drive (Type 1 or Type 2), a Sony Memory Stick or Sony Memory Stick Pro, or Sony Memory Stick Duo, Reduced Size MultiMediaCard (RS-MMC), or MultimediaCard Mobile (MMC Mobile), Secure Digital (SD) card, SmartMedia Card, or any other of known memory storage cards. Whatever the configuration of memory card/slot, the memory card supplies all, or substantially all, of the “internal” memory for the memoryless e-book reader. In an embodiment, an e-book source file is stored on the memory storage card, and once inserted into the card slot on the e-book reader, the memoryless e-book reader operates in a like manner to current e-book readers.

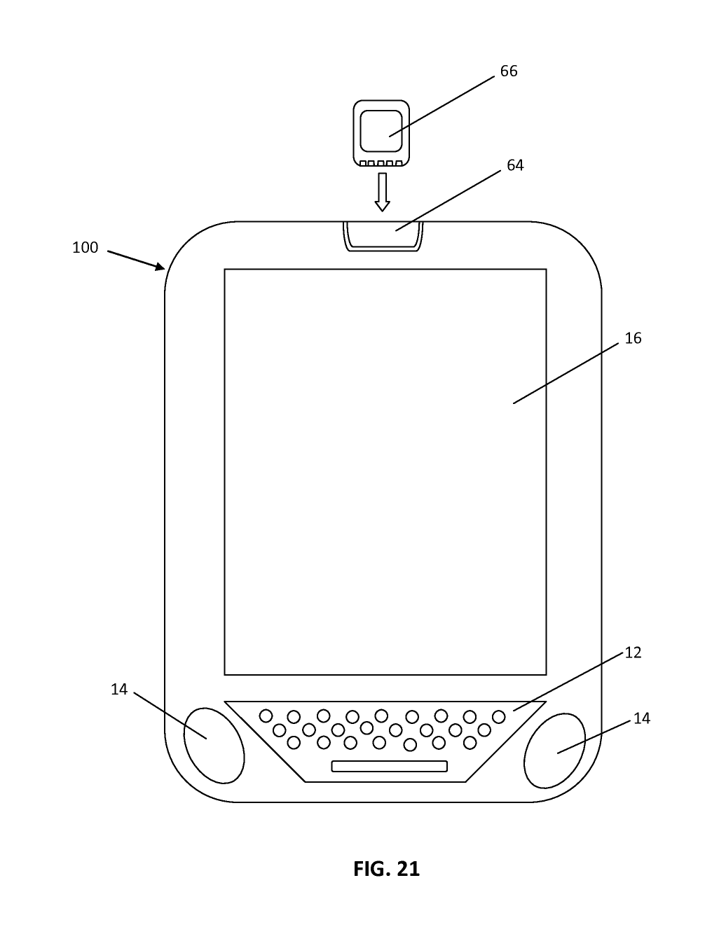

A memoryless e-book reader having little or no permanent internal memory is shown in FIG. 21. As shown, memoryless e-book reader 100 has a screen 16, a keyboard 12 and other functional buttons 14 as is known in the art of e-book readers. However, e-book reader 100 of FIG. 21 has little or no internal memory for storing e-book source files. In one embodiment, e-book reader 10 has less than 512 MB of internal memory.

In one embodiment, e-book reader 100 has less than 256 MB of internal memory. In one embodiment, e-book reader 100 has less than 128 MB of internal memory. In one embodiment, e-book reader 100 has less than 64 MB of internal memory. In one embodiment, e-book reader 100 has less than 32 MB of internal memory. In one embodiment, e-book reader 100 has less than 16 MB of internal memory. In one embodiment, e-book reader 100 has less than 8 MB of internal memory. In one embodiment, e-book reader 100 has less than 1 MB of internal memory. Instead of permanent internal memory, e-book reader 100 as shown in FIG. 21 utilizes memory storage devices 66 that can be inserted into a compatible card slot 64, after which time, the memory storage device serves the function of internal memory for storing e-book source files as long as the card is inserted. Executable instructions in the e-book reader's CPU can retrieve the e-book source file and display the e-book on the e-book reader's screen.

A “dummy” memoryless e-book reader having little or no internal memory can be useful for several purposes. First, libraries can use memoryless e-book readers to loan or check out, or rent, with the e-book source file being supplied on a memory storage card. Thus, a library patron can check out a memoryless e-book reader and a memory storage card containing an e-book source file for an e-book which the patron wishes to display for reading. In this manner reading material can be controlled for copyright purposes. Once the library patron has read the e-book, he or she returns the memory storage card, just as he or she would have returned a book. The memory storage card can then be catalogued for future lending to another library patron.

The memory storage device can be configured by means known in the art to prevent unauthorized distribution, including copying to, reading by, or writing to, other devices. In this manner, copyright protections can be readily enforced in situations, such as with lending libraries, in which unauthorized copying or distribution can occur. The memory storage device can be configured for predetermined limited use, or for one-time use, by electrical, electronic, or mechanical means. In an embodiment, the prevention of unauthorized distribution is accomplished electronically, wherein the memory storage device can have embedded in the software code therein instructions to permit only one, or a limited predetermined number, reading of the information displayed. In an embodiment, the prevention of unauthorized copying is accomplished electrically, wherein one or more of the electrical contacts of the memory storage device are designed to provide electrical contact upon insertion of the device into a compatible e-book reader, but become inoperable upon ejection of the device. For example, the electrical contacts can be attached to a plastic housing of the memory storage device at a leading edge only. Upon insertion the electrical contacts can glide in relatively easily to make operable electrical contact, but upon ejection, an un-joined edge of an electrical contact can become lodged against a portion of the e-book reader housing, which portion can then be bent back and/or broken off, such that the memory storage device is no longer usable. In an embodiment, a memory storage device comprises a plastic housing, as is currently known in the art, but with a difference: a portion of the plastic housing, or another portion of the memory storage device, is purposely alterable and/or frangible, so that upon insertion of the memory storage device into a compatible e-book reader the alterable/frangible portion offers functionality, such as functioning to aid in proper seating of the memory storage device, and upon ejecting of the memory storage device from a card slot of an e-book reader, the alterable/frangible portion is altered and/or broken off, after which the memory storage device is no longer operable in the e-book reader, and cannot be reused. For example, upon ejection a frangible portion necessary for proper seating can be altered, bent, broken off, or otherwise rendered unusable for further use.

In one embodiment, the invention is an e-book lending system comprising a collection of memory storage cards, at least one memory storage card having thereon an e-book source file for displaying an e-book on an e-book reader configured to accept the memory storage card. The memory storage cards can be kept “behind the counter” for checkout, or they can be housed in a plastic “cover” much like current DVD's are kept in video rental stores now. Thus, a library patron could “browse” the shelves of “covers”, which covers can have descriptive material about the book, the author, or anything else an author or publisher would like to have displayed. Once finished browsing, the library patron can take the “books” to the checkout desk, where a librarian or other authorized person can process a checkout of the memory storage card.

In one embodiment, a memory storage card can be loaned or rented in its “book cover”, much as DVD's are currently rented. In such an embodiment, the librarian or other authorized person may have to physically or electronically “release” the memory storage card for removal from the cover. Therefore, in an embodiment, the invention is a shelf, such as a book shelf, which can be a book shelf in a library, the shelf comprising plastic cases stored thereon, at least one of the plastic cases having inside at least one memory storage device on which is stored an e-book source file for reading by a compatible e-book reader or similar device (such as an iPad®, or other pad computer device). Of course, the shelf could also be a rack, a table, a counter, and the like.

After loan or rental of the memory storage card, the user can insert the memory storage card into his or her e-book reader, or insert it into a “dummy” memoryless reader supplied by the library. After insertion, the memoryless e-book reader can function in other ways like current e-book readers.

Second, in like manner schools, universities, and institutions can supply to their students, teachers, faculty, and researchers memoryless e-book readers. Elementary school students, for example, can be supplied with their school supplies memoryless e-book readers intended to be used for school assignments. Teachers or librarians can supply the desired memory storage cards for the various required textbooks, reading assignments, or other reading material. One benefit is that students need not carry many “paper” books around, but need merely carry a memoryless e-book reader and the required memory storage cards.

In like manner memory cards can be vended, such as from vending machines in airports, and be utilized in e-book readers, including in memoryless e-book readers.

In one embodiment memoryless e-book readers have no capability to “download” an e-book source file to permanent internal memory, either wirelessly or via wire. In another embodiment, however, in addition to, or instead of, supplying memory storage cards, the e-book reader can have a limited access port for facilitating a download of an e-book reader to permanent internal memory. The limited access port, like a specially configured USB port, can have a proprietary configuration such that only authorized persons in possession of the requisite connector type can effect a download of e-book source file content. For example, a modified USB-type connector could be utilized and controlled such that only authorized downloading entities, such as licensed libraries, are in possession of the requisite cable, and therefore can download e-book source file content onto an e-book reader. In an embodiment, the content downloaded via a limited access connection means can be time limited and/or copy protected, such that the downloaded content has a limited or confined existence.

Third, museum personnel, tour guides, symposia organizers, and the like, can offer museum guides, tour information, and symposia information, respectively, on portable memory that can be inserted into, or otherwise plugged, attached, or joined, to a memoryless e-book reader. In this manner, rather than have hard copy printed paper materials for user information, museums, tours, and symposia can benefit from the relatively easy-to-modify, and convenient to manage electronic form of information for their respective customers, guests, or audience members. For example, a museum that experiences changing exhibits can offer patrons a “dummy” memoryless e-book reader and an appropriate memory storage device for the current exhibit mix. Museum patrons can then refer to the e-book reader so equipped for the most current, up to date information as they visit the museum.

In an embodiment, e-book readers, including memoryless e-book readers, can have a port for receiving a memory storage device. As shown in FIG. 21, a memory storage device 66 can be designed to fit in to a memory slot 64 of an e-book reader 100, which can be adapted for lending or vending purposes. For example, e-book reader 100 can be vended separately from memory storage device 66, and likewise, e-book reader 100 can be vended separately from memory storage device 66. Memory storage device 66 can have stored thereon by means known in the art for storage of digital information, at least one e-book source file and any supporting electronic files, links, and other enhancing data. In this manner, lending libraries and/or vending machines can stock for lending/vending one or both of e-book reader 100 or memory storage device 66, for their respective customers.

Enhanced e-books and e-book readers of the present invention can have other features beneficial to an enhanced reading experience for a human reader. In one embodiment, enhanced e-book reader 10 is equipped with Bluetooth® technology or equivalent, as is well-known in the art. If Bluetooth (or equivalent for wireless data transmission) technology is used, an enhanced e-book can be listened to in a Bluetooth®-equipped vehicle through the vehicle's speaker system. In an embodiment the device is a handheld device such as a smart phone or an iPhone® or an iPod®. Additionally, ear buds, or other in-ear speakers for a Bluetooth®-equipped handheld device, such as a cellular telephone, can be used to listen to an enhanced e-book of the present invention by transmitting audio from the e-book via Bluetooth® wireless to the handheld device. In any case, of course, an enhanced e-book would have to be recognized with the other Bluetooth® device, as is known in the art, and can be implemented by means known in the art. In an embodiment an e-book can have radio-frequency transmission capability and can be coupled with devices as are known in the art to have audible readings thereof transmitted via a vehicle's radio/speaker system. Such systems can utilize tape players, CD payers, and the like, as is known in the art, such as the system utilized to play music from an Apple iPod over a vehicle's audio system.

Other structures, functions, features and benefits of current technology in e-books and e-book readers can be utilized in the present invention, but for brevity are not disclosed in detail herein. For this reason the following patents and applications are incorporated by reference herein for all their enabling teaching of various aspects of e-books and e-book reader technology, structure, function, and benefits, including features such as page switching, pagination, look-up features, annotation features, searching animation, display features, overall e-book configuration, bookmarking and place marking, text-to-speech features, flash file features, delivery and distribution, touch screens, hovering touch screens: US Pat. Appl. No. 2007/0168413, published in the name of Barletta et al. on July 19, 2007; U.S. Pat. No. 7,103,848, issued to Barsness et al. on Sep. 5, 2006; U.S. Pat. No. 5,663,748, issued to Huffman et al., on Sep.2, 1997; U.S. Pat. No. 4,159,417, issued to Rubincam on Jun. 26, 1979; U.S. Pat. No. 5,119,079, issued to Hube et al. on Jun. 2, 1992; U.S. Pat. No. 5,893,132, issued to Huffman et al. issued on Apr. 6, 1999; U.S. Pat. No. 6,493,734, issued to Sachs et al. on Dec. 10, 2002; U.S. Pat. No. 7,213,203, issued to Dunietz et al. on May 1, 2007; U.S. Pat. No. 6,331,867, issued to Eberhard et al. on Dec. 18, 2001; U.S. Pat. No. 7,350,704, issued to Barsness et al. on Apr. 1, 2008; U.S. Pat. No. 7,020,663, issued to Hay et al. on Mar. 28, 2006; U.S. Pat. No. 6,992,687, issued to Baird et al. on Jan. 31, 2006; U.S. Pat. No. 6,704,733, issued to Clark et al. on Mar. 9, 2003; U.S. Pat. No. 7,239,842, issued to Nijim on Jul. 3, 2007; U.S. Pat. No. 7,299,182, issued to Xie on Nov. 20, 2007; US Pat. Appl. No. 2005/0193330, published Sep. 1, 2005; and U.S. Pat. No. 7,047,411, issued to DeMello et al. on May 16, 2006; U.S. Pat. No. 5,761,681, issued to Huffman et al. on Jun. 2, 1998; U.S. Pat. No. 7,165,217, issued to Kondo on Jan. 16, 2007; US Pat. Appl. No. 2008/0243788, published Oct. 2, 2008, entitled Search of Multiple Content Sources on a User Device; US Pat. Appl. No. 2008/0243828, published Oct. 2, 2008, entitled Search and Indexing on a User Device; US Pat. Appl. No. 2008/0293450, published Nov. 27, 2008, entitled Consumption of Items via a User Device; US Pat. Appl. No. 2008/0294674, published Nov. 27, 2008, entitled Managing Status of Search Index Generation; US Pat. Appl. No. 2008/0295021, published Nov.27, 2008, entitled Zone-Associated Objects; and US Pat. Appl. No. 2008/0295039, published Nov. 27, 2008, entitled Animations; U.S. Ser. No. 11/246,293, filed on Mar. 29, 2006, entitled “Electronic Media Reader Display,” naming the inventors of Whitehorn, et al.; U.S. Ser. No. 11/246,294, filed on Mar. 29, 2006, entitled “Electronic Media Reader Keypad,” naming the inventors of Thomas J. Hobbs, et al.; U.S. Ser. No. 11/246,295, filed on Mar. 29, 2006, entitled “Wedge-Shaped Electronic Media Reader,” naming the inventors of Whitehorn et al.; U.S. Ser. No. 11/277,898, filed on Mar. 29, 2006, entitled Page Turner For Handheld Electronic Book Reader Device,” naming the inventors of Gregg E. Zehr, et al.; U.S. Ser. No. 11/277,893, filed on Mar. 29, 2006, entitled “Handheld Electronic Book Reader Device Having Dual Displays,” naming the inventors of Gregg E. Zehr, et al.; U.S. Ser. No. 11/277,873, filed on Mar. 29, 2006, entitled “Handheld Electronic Book Reader Device Having Asymmetrical Shape,” naming the inventors of Gregg E. Zehr, et al.; and U.S. Ser. No. 11/277,879, filed on Mar. 29, 2006, entitled “Keyboard Layout for Handheld Electronic Book Reader Device,” naming the inventors of Gregg E. Zehr, et al.; U.S. Pat. No. 7,307,485, issued to Snyder, et al. on Dec. 11, 2007; U.S. Ser. No. 12/408,504, filed Mar. 20, 2009, entitled “Dynamic Visual Feature Coordination in an Electronic Hand Held Device,” naming Samuel F. Saunders; U.S. Ser. No. 11/397,737, filed Apr. 5, 2006, entitled “Finger Activated Reduced Keyboard and a Method for Performing Text Input,” naming the inventor Daniel Suraqui; U.S. Ser. No. 11/626,353, filed on Jan. 23, 2007, entitled “Bimodal User Interface Paradigm for Touch Screen Devices,” naming Louis B. Rosenberg; U.S. Pat. No. 5,565,894, issued Oct. 15, 1996, entitled “Dynamic Touchscreen Button Adjustment Mechanism,” naming Bates et al.; U.S. Ser. No. 10/830,788, filed Apr. 23, 2004, entitled “Method and Apparatus for Improving Accuracy of Touch Screen Input Devices,” naming Cake et al.; U.S. 2006/0022955, Ser. No. 10/927,925, entitled “Visual Expander”, filed Aug. 26, 2004, naming Kennedy; U.S. 2006/0132460, Ser. No. 11/018,679, entitled “Touch Screen Accuracy”, filed Dec. 22, 2004, naming Kolmykov-Zotov, et al.; U.S. 2006/0161871, Ser. No. 11/241,839, entitled “Proximity Detector in Handheld Device”, filed Sep. 30, 2005, in the name of Hotelling et al.; U.S. Pat. No. 5,119,079, entitled “Touch Screen User Interface with Expanding Touch Locations For a Reprographic Machine” filed Sep. 17, 1990, in the name of Hube et al.; U.S. Pat. No. 7,002,556, entitled “Touch Responsive Display Unit and Method,” filed Jun. 18, 2002 in the name of Tsukada et al.; U.S. 2008/0094368, Ser. No. 11/850,013, entitled “Portable Electronic Device, Method, and Graphical user Interface for Displaying Structured Electronic Documents,” filed Sep. 4, 2007 in the name of Ording et al.; U.S. 2010/0156807, Ser. No. 12/340,180, entitled “Zooming Keyboard/Keypad”, filed Dec. 19, 2008 in the name of Stallings et al.

What is claimed is:

1. An e-book reader, the e-book reader comprising a touch screen display, the touch screen display being an electronic paper display having a contrast ratio greater than 7:1 and a viewing angle up to 180 degrees, the e-book reader having dimensions of between 100 mm and 140 mm wide and between 140 mm and 225 mm long, and between 8 mm and 16 mm thick, the e-book reader weighing between 100 grams and 300 grams, the e-book reader having stored in memory executable instructions and a source file of an electronic work, the source file being stored in the memory in a format selected from the group consisting of AZW, TXT, PDF, unprotected MOBI, and PRC, the electronic work being a work of fiction involving a plurality of characters, the executable instructions executing a search feature for a human reader to find context-relevant information from within the work of fiction, the context-relevant information being related to at least one of the plurality of characters, the context-relevant information reminding the reader of the at least one of the plurality of characters' relationship to other characters and events in the work of fiction, the context-relevant information being displayed upon a human reader touching a name of the at least one of the plurality of characters on the touch screen.

2. The e-book reader of claim 1, wherein the e-book reader memory is between 1 and 4 GB.

3. The e-book reader of claim 1, wherein the electronic work further comprises a plurality of places, and the search feature allows the human reader to find context relevant information related to at least one of the plurality of places.

4. The e-book reader of claim 1, wherein the name of the at least one of the plurality of characters is a searchable term, the searchable term appearing in a first portion of the work of fiction, and upon touching the searchable term on the touch screen by a human reader, executable instructions in the memory cause to be displayed a second portion of the work of fiction wherein the searchable term appears.

5. The e-book reader of claim 4, wherein the selected term in the second portion is highlighted for easy identification by the human reader.

6. The e-book reader of claim 5, wherein in addition to the searchable term being highlighted, n words around the searchable term can be highlighted as well, with n being a positive integer.

7. The e-book reader of claim 1, the e-book reader further comprising in memory translations such that upon tapping a word or highlighting a phrase in one language, the word or phrase is translated into another language.

8. The e-book reader of claim 1, wherein the executable instructions include instructions, which, when executed upon by a human reader selecting a word or phrase by touching the touch screen display, retrieve at least one machine translation of the word or phrase from a web-based translation tool for display on the touch screen display.

9. The enhanced e-book of claim 1, wherein upon the human reader highlighting by touching the name of the at least one of the plurality of characters on the touch screen display and initiating a search function, the executable instructions cause the display screen to show the first instance of the name in the electronic work.

10. The enhanced e-book of claim 1, wherein upon the human reader touching the name of the at least one of the plurality of characters on the touch screen display, the touch screen display shows all the instances of the name.

11. The e-book reader of claim 1, further comprising in the memory context-specific information tailored to the work of fiction, wherein upon selecting by touching the touch screen display the name of the at least one of the plurality of characters on the touch screen display, the executable instructions cause to be displayed on the touch screen display context-specific information related to the at least one of the plurality of characters.

12. An e-book reader, the e-book reader comprising a touch screen, the touch screen being an electronic paper display having a contrast ratio greater than 7:1, the e-book reader weighing between 100 grams and 300 grams and having internal memory for storing executable instructions and a source file of an electronic work, the source file being stored in the memory in AZW format, the electronic work being a work of fiction having a storyline and further including searchable information relevant to a person, a place, or a thing in the work of fiction, the executable instructions displaying the information after a human reader touches the touch screen at a location displaying the person, the place, or the thing, the information reminding the human reader of the person's, the place's or the thing's relationship to the storyline.

13. The e-book reader of claim 12, wherein the information offers a reminder to a human reader of information the human reader read earlier in the work but subsequently forgot.

14. The e-book reader of claim 12, wherein the e-book reader has dimensions of between 100 mm and 140 mm wide, and between 140 mm and 225 mm long, and between about 8 mm and 16 mm thick.

15. The e-book reader of claim 12, further comprising context-specific information tailored to the work of fiction, wherein the executable instructions execute a search for and display the context-specific information upon a human reader touching the touch screen display at a location displaying the person, the place, or the thing.

16. The e-book reader of claim 12, the e-book reader further having in memory translations such that upon tapping a word or highlighting a phrase in one language, the word or phrase is translated into another language.

17. The e-book reader of claim 12, wherein the executable instructions include instructions, which, when executed upon by a human reader selecting a word or phrase by touching the touch screen display, retrieve at least one machine translation of the word or phrase from a web-based translation tool for display on the touch screen display.

18. The enhanced e-book of claim 12, wherein upon the human reader highlighting by touching the name of the at least one of the plurality of characters on the touch screen and initiating a search function, the display screen shows the first instance of the name in the electronic work.

19. An e-book reader, the e-book reader comprising a touch screen display, the touch screen display being a capacitive electronic paper display having a contrast ratio greater than 7:1 and a viewing angle of about 180 degrees, the e-book reader having dimensions of between 100 and 140 mm wide, and between 140 and 225 mm long, and between about 8 and 16 mm thick, the e-book reader weighing between 100 and 300 grams, the e-book reader having stored in memory executable instructions and a source file of an electronic work, the source file being stored in the memory in a format selected from the group consisting of AZW, TXT, PDF, unprotected MOBI, and PRC, the electronic work being a work of fiction or non-fiction, the executable instructions executing a search feature for a human reader to find and display context-relevant information from within the electronic work, the displayed context-relevant information being related to at least one searchable term, the displayed context-relevant information reminding the reader of the relevance of the searchable term in the work of fiction or non-fiction, the context-relevant information being displayed upon a human reader touching an instance of the searchable term.

20. The e-book reader of claim 19, wherein the base work is a work of fiction and wherein the searchable term is one of a person and a place in the work of fiction.

21. The e-book reader of claim 19, the e-book reader further comprising in memory translations such that upon tapping a word or highlighting a section, the executable instructions cause the word or section can be translated into another language and displayed on the touch screen display.

22. The e-book reader of claim 19, wherein upon the human reader touching a searchable term that is the name of the at least one of a plurality of characters on the touch screen the display, the executable instructions cause all the instances of the name to be displayed on the touch screen display.

23. The e-book reader of claim 19, wherein upon the human reader touching on the touch screen the searchable term that is the name of the at least one of a plurality of persons, places, or things, the touch screen display shows all the instances of the person, place, or thing.

24. The e-book reader of claim 19, wherein upon the human reader touching on the touch screen the searchable term that is the name of at least one of a plurality of persons, places, or things the touch screen display shows the first instances of the person, place, or thing.

25. The e-book reader of claim 19, further comprising context-specific information, wherein the executable instructions execute a search for and display the context-specific information upon a human reader touching the touch screen display the searchable term.

26. An e-book reader, the e-book reader comprising a touch screen display, the touch screen display being a capacitive electronic paper display having a contrast ratio greater than 7:1 and a viewing angle of about 180 degrees, the e-book reader having stored in memory executable instructions and a source file of an electronic work, the source file being stored in the memory in a format selected from the group consisting of AZW, TXT, PDF, unprotected MOBI, and PRC, the electronic work being a work of fiction or non-fiction, the executable instructions executing a search feature for a human reader to find and display context-relevant information from within the electronic work, the displayed context-relevant information being related to at least one searchable term, the displayed context-relevant information reminding the reader of the relevance of the searchable term in the work of fiction or non-fiction, the context-relevant information being displayed upon a human reader touching an instance of the searchable term, the executable instructions further including instructions, which, when executed upon by a human reader selecting a word or phrase by touching the touch screen display, retrieve at least one machine translation of the word or phrase from a web-based translation tool for display on the touch screen display.

27. The e-book reader of claim 26, wherein the e-book reader has dimensions of between 100 mm and 140 mm wide, and between 140 mm and 225 mm long, and between about 8 mm and 16 mm thick.

28. The e-book reader of claim 26, further comprising context-specific information tailored to the work of fiction or non-fiction, wherein the executable instructions execute a search for and display the context-specific information upon a human reader touching the touch screen display at a location displaying the searchable term.

29. The e-book reader of claim 26, wherein the translation is a machine translation.

30. The e-book reader of claim 26, further comprising context-specific information tailored to the work of fiction or non-fiction, wherein the executable instructions execute a search for and display the context-specific information upon a human reader touching the touch screen display at a location displaying the searchable term.
